(19) United States
(12) Patent Application Publication
(10) Pub. No.: US 2022/0150546 A1
(43) Pub. Date: May 12, 2022

(54) METHODS FOR RECOVERY POINT PROCESS FOR VIDEO CODING AND RELATED APPARATUS

(71) Applicant: Telefonaktiebolaget LM Ericsson (publ), Stockholm (SE)

(72) Inventors: Rickard SJÖBERG, Stockholm (SE); Martin PETTERSSON, Vallentuna (SE); Mitra DAMGHANIAN, Upplands-Bro (SE)

(21) Appl. No.: 17/437,905

(22) PCT Filed: Mar. 10, 2020
(86) PCT No.: PCT/SE2020/050258

§ 371 Date: Sep. 10, 2021

Related U.S. Application Data
(60) Provisional application No. 62/816,443, filed on Mar. 11, 2019.

(51) Int. Cl. H04N 19/70; H04N 19/172; H04N 19/169; H04N 19/176; H04N 19/105; H04N 19/107

(52) U.S. Cl. CPC H04N 19/70; H04N 19/172; H04N 19/107; H04N 19/176; H04N 19/105; H04N 19/188

(57) ABSTRACT

A method of decoding a set of pictures from a bitstream is provided. The method includes identifying a recovery point in the bitstream from a recovery point indication. The recovery point specifies a starting position in the bitstream for decoding the set of pictures. The method further includes decoding the recovery point indication to obtain a decoded set of syntax elements. The method further includes deriving information for generating a set of unavailable reference pictures from the decoded set of syntax elements before any of the coded picture data is parsed by a decoder. The method further includes generating the set of unavailable reference pictures based on the derived information. The method further includes decoding the set of pictures after generation of the set of unavailable reference pictures. Methods performed by an encoder are also provided.

### TECHNICAL FIELD

The present disclosure relates generally to methods of encoding a recovery point indication with information of how to generate unavailable reference pictures in a bitstream and methods of decoding a set of pictures from a bitstream. The present disclosure also relates to an encoder configured to encode a recovery point indication and a decoder configured to decode a set of pictures.

### BACKGROUND

High Efficiency Video Coding (HEVC) and Versatile Video Coding (VVC) will now be discussed. HEVC is a block-based video codec standardized by ITU-T and MPEG that utilizes both temporal and spatial prediction. Spatial prediction may be achieved using intra (I) prediction from within the current picture. Temporal prediction may be achieved using uni-directional (P) or bi-directional (B) intra prediction on block level from previously decoded reference pictures. In the encoder, the difference between the original pixel data and the predicted pixel data, referred to as the residual, may be transformed into the frequency domain, quantized and then entropy coded before transmitted together with prediction parameters such as prediction mode and motion vectors, also entropy coded. The decoder may perform entropy decoding, inverse quantization and inverse transformation to obtain the residual, and then may add the residual to an intra or inter prediction to reconstruct a picture.

MPEG and ITU-T are working on the successor to HEVC within the Joint Video Exploratory Team (JVET). The name of this video codec under development is VVC.

Components of an image will now be discussed. A video sequence comprises a series of images where each image includes one or more component. Each component can be described as a two-dimensional rectangular array of sample values. An image in a video sequence comprises three components; one luma component Y where the sample values are luma values and two chroma components Cb and Cr, where the sample values are chroma values. The dimensions of the chroma components may be smaller than the luma components by a factor of two in each dimension to save bits in compression. For example, the size of the luma component of an HD image may be 1920×1080 and the chroma components may each have the dimension of 960×540. Components are sometimes referred to as color components.

Blocks and units will now be discussed. A block is one two-dimensional array of samples. In video coding, each component may be split into blocks and the coded video bitstream comprises a series of coded blocks. In video coding, an image may be split into units that cover a specific area of the image. Each unit comprises all blocks from all components that make up that specific area and each block belongs to one unit. The macroblock in H.264 and the Coding unit (CU) in HEVC are examples of units.

A block may alternatively be described as a two-dimensional array that a transform used in coding is applied to. These blocks may be referred to as “transform blocks”. Alternatively, a block may be described as a two-dimensional array that a single prediction mode is applied to. These blocks may be referred to as “prediction blocks”. In this disclosure, the word block is not tied to one of these descriptions but that the descriptions herein may apply to either “transform blocks” or “prediction blocks”.

NAL units will now be discussed. Both HEVC and VVC define a Network Abstraction Layer (NAL). All the data, e.g. both Video Coding Layer (VCL) or non-VCL data in HEVC and VVC is encapsulated in NAL units. A VCL NAL unit may contain data that represents picture sample values. A non-VCL NAL unit may contain additional associated data such as parameter sets and supplemental enhancement information (SEI) messages. The NAL unit in HEVC begins with a header which may specify the NAL unit type of the NAL unit that identifies what type of data is carried in the NAL unit, the layer ID and the temporal ID for which the NAL unit belongs to. The NAL unit type is transmitted in the nal unit type codeword in the NAL unit header and the type indicates and may define how the NAL unit should be parsed and decoded. The rest of the bytes of the NAL unit is payload of the type indicated by the NAL unit type. A bitstream comprises a series of concatenated NAL units. A bitstream comprises a series of concatenated NAL units.

Syntax for the NAL unit header in HEVC is shown in FIG. 1.

The first byte of each NAL unit in VVC and HEVC contains the nal unit type syntax element. A decoder or bitstream parser can conclude how the NAL unit should be handled, e.g. parsed and decoded, after looking at the first byte. A VCL NAL unit provides information about the picture type of the current picture. The NAL unit types of the current version of the VVC draft at the time of writing, JVET-M1001-v5, is shown in FIG. 2.

The decoding order is the order in which NAL units shall be decoded, which is the same as the order of the NAL units within the bitstream. The decoding order may be different from the output order, which is the order in which decoded pictures are to be output, such as for display, by the decoder.

Intra random access point (IRAP) pictures and the coded video sequence (CVS) will now be discussed. For single layer coding in HEVC, an access unit (AU) is the coded representation of a single picture. An AU may include several video coding layer (VCL) NAL units as well as non-VCL NAL units.

An Intra random access point (IRAP) picture in HEVC is a picture that does not refer to any pictures other than itself for prediction in its decoding process. The first picture in the bitstream in decoding order in HEVC must be an IRAP picture but an IRAP picture may additionally also appear later in the bitstream. HEVC may specify three types of IRAP pictures, the broken link access (BLA) picture, the instantaneous decoder refresh (IDR) picture and the clean random access (CRA) picture.

A coded video sequence (CVS) in HEVC is a series of access units starting at an IRAP access unit up to, but not including the next IRAP access unit in decoding order.

IDR pictures always start a new CVS. An IDR picture may have associated random access decodable leading (RADL) pictures. An IDR picture does not have associated RASL pictures.

BLA pictures also starts a new CVS and has the same effect on the decoding process as an IDR picture. However, a BLA picture in HEVC may contain syntax elements that specify a non-empty set of reference pictures. A BLA picture may have associated RASL pictures, which are not output by the decoder and may not be decodable, as they may contain references to pictures that may not be present in the bitstream. A BLA picture may also have associated RADL pictures, which are decoded.

A CRA picture may have associated RADL or RASL pictures. As with a BLA picture, a CRA picture may contain syntax elements that specify a non-empty set of reference pictures. For CRA pictures, a flag can be set to specify that the associated RASL pictures are not output by the decoder, because they may not be decodable, as they may contain references to pictures that are not present in the bitstream. A CRA may or may not start a CVS.

Parameter sets will now be discussed. HEVC may specify three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs.

Tiles will now be discussed. HEVC and the draft VVC video coding standard includes a tool called tiles that divides a picture into rectangular spatially independent regions. Tiles in the draft VVC coding standard are very similar to the tiles used in HEVC. Using tiles, a picture in VVC can be partitioned into rows and columns of samples where a tile is an intersection of a row and a column. FIG. 2 shows an example of a tile partitioning using 4 tile rows and 5 tile columns resulting in a total of 20 tiles for the picture. FIG. 3 is an exemplary tile partitioning.

Block structures will now be discussed. In HEVC and the draft VVC specification each picture is partitioned into square blocks called coding tree units (CTU). The size of all CTUs are identical and the partition is done without any syntax controlling it. Each CTU is further partitioned into coding units (CU) that can have either square or rectangular shapes. A coded picture may include of a series of coded CTUs according to a determined scan order that for example may be a raster scan order. Other CTU scan orders may occur, for example when tiles are used. Then the coded picture may include of a series of coded tiles in tile raster scan order wherein each coded tile may include a series of CTUs in CTU raster scan order.

Reference picture management will now be discussed. Pictures in HEVC are identified by their picture order count (POC) values, also known as full POC values. Each slice contains a code word, pic_order_cnt_lsb, that shall be the same for all slices in a picture. pic_order_cnt_lsb is also known as the least significant bits (lsb) of the full POC since it is a fixed-length code word and only the least significant bits of the full POC is signaled. Both encoder and decoder keep track of POC and assign POC values to each picture that is encoded/decoded. The pic_order_cnt_lsb can be signaled by 4-16 bits. There is a variable MaxPicOrderCntLsb used in HEVC which is set to the maximum pic_order_cnt_lsb value plus 1. This means that if 8 bits are used to signal pic_order_cnt_lsb, the maximum value is 255 and MaxPicOrderCntLsb is set to 2\hat{ }8=256. The picture order count value of a picture is called PicOrderCntVal in HEVC. Usually, PicOrderCntVal for the current picture is simply called PicOrderCntVal.

Reference picture management in HEVC is done using reference pictures sets (RPS). The reference picture set is a set of reference pictures that is signaled in the slice headers. When the decoder has decoded a picture, it is put together with its POC value in a decoded picture buffer (DPB). When decoding a subsequence picture, the decoder parses the RPS syntax from the slice header and constructs lists of reference picture POC values. These lists are compared with the POC values of the stored pictures in the DPB and the RPS may specify which pictures in the DPB to keep in the DPB and which pictures to remove. All pictures that is not included in the RPS are removed from the DPB. A picture that is kept in the DPB is marked either as a short-term reference pictures or as a long-term reference picture according to the decoded RPS information.

One property of the HEVC reference picture management system is that the status of the DPB as it should be before the current picture is decoded is signaled for every slice. This enables the decoder to compare the signaled status with the actual status of the DPB and determine if any reference picture is missing.

The reference picture management in the draft VVC specification differ slightly from the one in HEVC. In HEVC, the RPS is signaled and the reference picture lists to use for Inter prediction is derived from the RPS. In the draft VVC specification, the reference pictures lists (RPL) are signaled and the RPS is derived. However, in both specifications, signaling of what pictures to keep in the DPB, what pictures should be short-term and long-term is done. Using POC for picture identification and determination of missing reference pictures is done the same in both specifications.

Recovery points will now be discussed. A recovery point is used to perform a random-access operation in a bitstream using only temporal predicted pictures. A recovery point is also useful for refreshing the video in case of video data loss.

A decoder performing a random-access operation in a bitstream decodes all pictures in a recovery point period without outputting them. When it reaches the last picture of the recovery point period, the recovery point picture, the video has been fully refreshed and the recovery point picture and the following picture may be outputted. The recovery point mechanism is sometimes referred to as gradual decoding refresh (GDR) since it refreshes the video gradually picture by picture.

In practice, a GDR is created by gradually refreshing the video using intra coded blocks (e.g. CTUs). For each picture in the recovery point period a larger part of the video is refreshed until the video has been fully refreshed.

FIG. 4 illustrates two different example patterns for gradual decoding refresh of the video, vertical lines and a pseudo-random pattern. FIG. 4 illustrates gradual decoding refresh over five pictures. White blocks are non-refreshed or “dirty” blocks, dark grey blocks are intra coded blocks, and dark and medium grey blocks are refreshed or “clean” blocks. The top row of FIG. 4 illustrates gradual refresh using vertical lines of intra coded blocks. The bottom row of FIG. 4 illustrates gradual refresh using a pseudo-random pattern. Other common patterns may include horizontal lines and block-by-block in raster scan order. The blocks in the example of FIG. 4 may be CTUs.

Refreshed blocks may be configured to only predict from other refreshed blocks in the current (spatial intra prediction) and previous pictures (temporal prediction). This prevents artifacts from spreading into refreshed areas between pictures.

Slices or tiles can be used to restrict predictions between non-refreshed and refreshed blocks in an efficient way since slice and tile boundaries may turn off predictions across the boundaries but allow predictions elsewhere. FIG. 5 illustrates an example of using the restrictions in tiles for GDR. In FIG. 5, tile borders are shown with thick lines. One tile is used for the clean area and one tile is used for the dirty area. In the first example in FIG. 5, the picture may be divided into two tiles where one tile comprises the refreshed blocks and the other tile comprises the non-refreshed blocks. In the example of FIG. 5, the tile distribution and tile sizes are then not constant over time.

Some degree of artifacts could also be allowed by not restricting, or just partially restricting temporal and spatial prediction to refreshed areas.

Recovery point SEI message in HEVC will now be discussed. A mechanism used in AVC and HEVC for sending messages in the bitstream that are not strictly needed for the decoding process but may aid the decoder in various ways, is the supplemental enhancement information (SEI) messages. SEI messages are signaled in a SEI NAL unit and are not normative for the decoder to parse.

One SEI message defined by HEVC and AVC is the Recovery Point SEI message. The recovery Point SEI message is sent in the position (at the picture) in the bitstream where the recovery period starts. When a decoder tunes in to the bitstream, it may start decoding all pictures in decoding order from this position without outputting them, until it reaches the recovery point picture, from where all pictures should be fully refreshed and ok to output.

The syntax for the recovery point SEI in HEVC is illustrated in FIG. 6. In FIG. 6, recovery_point_cnt may specify the recovery point picture from where the decoder can start outputting pictures.

Still referring to FIG. 6, and exact_match_flag equal to 1 may specify that the recovery point picture resulting from tuning in to the recovery point exactly matches the recovery point picture as if the bitstream was decoded from the previous IRAP picture. exact_match_flag equal to 0 may specify that the recovery point picture should be virtually the same as if the bitstream was decoded from the previous IRAP picture, but it may not be an exact match.

The broken link flag is used to indicate if there is a broken link in the bitstream at the location of the SEI message. If the broken link flag is set equal to 1, pictures produced by starting the decoding at the location of a previous IRAP picture may contain undesirable visual artifacts that should not be displayed before the recovery picture.

Work on Recovery Points in JVET will now be discussed. At the 11th JVET meeting in Ljubljana an ad hoc group (AHG14) was formed to study recovery points for VVC.

At the 12th meeting in Macao in October 2018, the following two proposals were discussed:

In JVET-L0079, it is first discussed what non-normative changes needs to be done to the coding tools on the encoder side to enable exact match using the Recovery point SEI message in HEVC. The coding tools discussed are advanced temporal MV prediction (ATMVP), intra prediction, intra block copy, inter prediction, and in-loop filters comprising the sample adaptive offset (SAO) filter, deblocking filters and the adaptive loop filter (ALF). The document also discusses some normative changes that could be applied to the coding tools to increase compression efficiency.

JVET-L0161 proposes to signal information about the intra refresh in the SPS, PPS and at the slice level. The signaled intra refresh information in SPS/PPS comprises a flag for enabling intra refresh tools, intra refresh mode (column, line, pseudo), size of the intra refresh pattern (e.g. width of column or length of line) and intra refresh delta QP. The signaled intra refresh information at slice level comprises intra refresh direction (right to left/left to right/top to bottom/bottom to top) to be used to determine motion vector constraints, and intra refresh position specifying the position of the intra refresh blocks given by the size of the intra refresh pattern. The intra refresh pattern is derived at the picture level according to the intra refresh position values if a CU belongs to the intra refresh area.

At the 13th meeting in Marrakesh in January 2019, input document JVET-M0529 proposed to indicate a recovery point using a NAL unit type instead of using an SEI message as in HEVC and AVC. The syntax proposed contained only one code word, recovery_poc_cnt, that is similar to the usage in HEVC. The proposed syntax is shown in FIG. 7, which shows recovery point NAL unit syntax proposed in JVET-M0529.

A decoding process to start decoding at a recovery point was also proposed. The proposed process included a definition of the RPB access unit as the access unit associated with the recovery point NAL unit as well as the following:
If an RPB access unit containing an RPI NAL unit is not the first access unit in the CVS and a random access operation is not initialized at the RPB access unit, the RPI NAL unit in the RPB access unit shall be ignored.
Otherwise, if an RPB access unit containing an RPI NAL unit is the first access unit in the CVS or a random access operation is initialized at the RPB access unit, the following applies:
   The decoder shall generate all reference pictures included in the RPS.
   The poc_msb_cycle_val for the RPB picture shall be set to 0 when deriving the PicOrderCntVal for the RPB picture
   The RPB picture and all pictures that follow the RPB picture in decoding order shall be decoded.
   The RPB picture and all pictures that follow the RPB picture in decoding order until but not including the recovery point picture, shall not be output.
   Any SPS or PPS RBSP that is referred to by the picture in a RPB access unit or by any picture following that picture in decoding order shall be available to the decoding process prior to its activation.

This process means that JVET-M0529 proposed that a CVS may start at a recovery point.

Notwithstanding the decoding of pictures discussed above, there continues to exist demand for improved recovery point processing in encoding and decoding.

### SUMMARY

According to various embodiments of inventive concepts, a method of decoding a set of pictures from a bitstream is provided. The method includes identifying a recovery point in the bitstream from a recovery point indication. The recovery point specifies a starting position in the bitstream for decoding the set of pictures. The set of pictures includes a first picture that is the first picture that follows the recovery point indication in a decoding order in the set of pictures and wherein the set of pictures include coded picture data. The method further includes decoding the recovery point indication to obtain a decoded set of syntax elements. The recovery point indication includes a set of syntax elements. The method further includes deriving information for generating a set of unavailable reference pictures from the decoded set of syntax elements before any of the coded picture data is parsed by a decoder. The method further includes generating the set of unavailable reference pictures based on the derived information. The method further includes decoding the set of pictures after generation of the set of unavailable reference pictures.

In some embodiments, the decoding the set of pictures is initialized at the recovery point, the method further includes determining a position of a first picture in the set of pictures. The method further includes determining a position of a second picture in the set of pictures. The method further includes decoding the first picture and all other pictures in the set of pictures in the recovery period before the second picture in the decoding order without outputting the decoded pictures. The method further includes decoding and outputting the second picture.

In some embodiments, the method further includes performing a random access operation at the recovery point.

In some embodiments, the method further includes rendering each picture in the set of pictures for display on a screen based on decoding the pictures from the bitstream after generation of the set of unavailable reference pictures.

In some embodiments, the method further includes receiving the bitstream over a radio and/or network interface from a remote device.

Corresponding embodiments of inventive concepts for a decoder and a computer program are also provided.

According to other embodiments of inventive concepts, a method of encoding a recovery point indication with information of how to generate unavailable reference pictures in a bitstream is provided. The method includes encoding a first set of pictures to the bitstream. The method further includes determining a set of reference pictures that would be unavailable to a decoder if decoding started in the bitstream after the first set of pictures. The method further includes encoding a recovery point indication to the bitstream. The recovery point indication includes a set of syntax elements for the set of reference pictures. The method further includes encoding (a second set of pictures to the bitstream. The at least one picture in the second set of pictures references a picture from the first set of pictures.

Corresponding embodiments of inventive concepts for a decoder and a computer program are also provided.

According to other embodiments of inventive concepts, a method of encoding a recovery point indication with information of how to generate unavailable reference pictures in a bitstream is provided. The method includes encoding a first set of pictures to the bitstream. The method further includes determining a set of reference pictures that would be unavailable to a decoder if decoding started in the bitstream after the first set of pictures. The method further includes encoding a recovery point indication to the bitstream. The recovery point indication includes a set of syntax elements for the set of reference pictures. The method further includes encoding a second set of pictures to the bitstream. The at least one picture in the second set of pictures references a picture from the first set of pictures.

Corresponding embodiments of inventive concepts for an encoder and a computer program are also provided.

In some approaches, generation of reference pictures can only be done when it is known what reference pictures should be present in the RPS. This may be derived when the slice header (for HEVC) or tile group header (for the draft VVC) is decoded. This means that generation of reference pictures cannot be done before the slice header or the tile group header is received.

Various embodiments of the present disclosure may provide solutions to these and other potential problems. In various embodiments of the present disclosure, information may be added to a recovery point such that the information in the recovery point may be sufficient for generating reference pictures for recovery point random access. As a consequence, generation of pictures may be dome before a slice header or a tile group header is received.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates syntax for a NAL unit header in HEVC;

FIG. 2 illustrates NAL unit types in VCC;

FIG. 3 illustrates an exemplary tile partitioning;

FIG. 4 illustrates gradual decoding refresh over five pictures;

FIG. 5 illustrates an example of using the restrictions in tiles for GDR. Tile borders are shown with thick lines. One tile is used for the clean area and one tile is used for the dirty area;

FIG. 6 illustrates HEVC recovery point SEI NAL unit syntax;

FIG. 7 illustrates recovery point NAL unit syntax proposed in WET-M0529;

FIG. 8 shows an example of a reference structure for low-delay video according to some embodiments of inventive concepts;

FIG. 9 shows an example of generation of unavailable reference pictures from information in the recovery point indication data according to some embodiments of inventive concepts;

FIG. 10 shows an example bitstream with recovery point indication NAL unit. NAL unit headers are marked in gray according to some embodiments of inventive concepts;

FIG. 11 shows an example of recovery point indication RBSP syntax according to some embodiments of inventive concepts;

FIG. 12 shows an example of NAL unit type codes and NAL unit type classes according to some embodiments of inventive concepts;

FIG. 13 shows an example of syntax for a recovery point indication in a picture header according to some embodiments of inventive concepts;

FIG. 14 shows an example of a recovery point indication as a NAL unit type in a VCL NAL unit according to some embodiments of inventive concepts;

FIG. 15A shows an example of syntax for contents of a set of recovery point indication syntax elements of a recovery point indication signaled in an SEI message according to some embodiments of inventive concepts;

FIG. 15B shows an example syntax for signaling the set of recovery point indication syntax elements in PPS according to some embodiments of inventive concepts;

FIGS. 16-20 are flow charts illustrating operations of a decoder according to some embodiments of inventive concepts;

FIG. 21 is a block diagram of a decoder according to some embodiments of inventive concepts;

FIG. 22 is a block diagram of an encoder according to some embodiments of inventive concepts; and

FIG. 23 is a flow chart illustrating operations of an encoder according to some embodiments of inventive concepts.

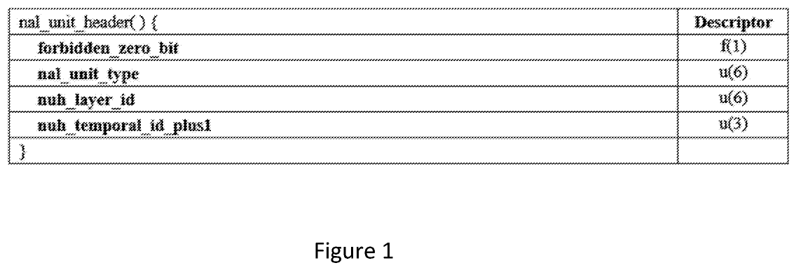

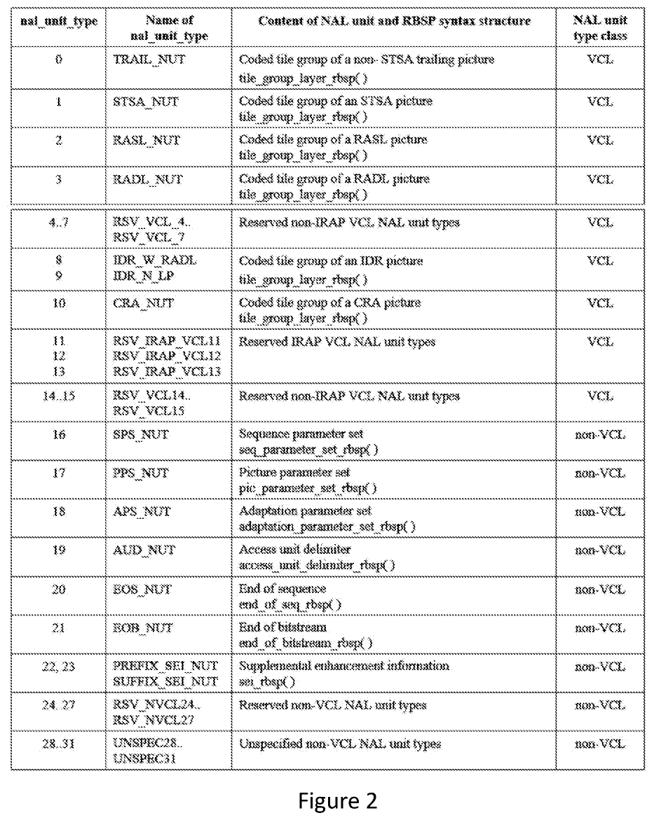

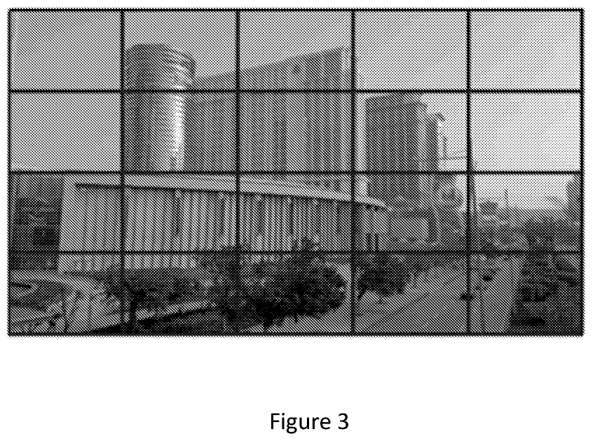

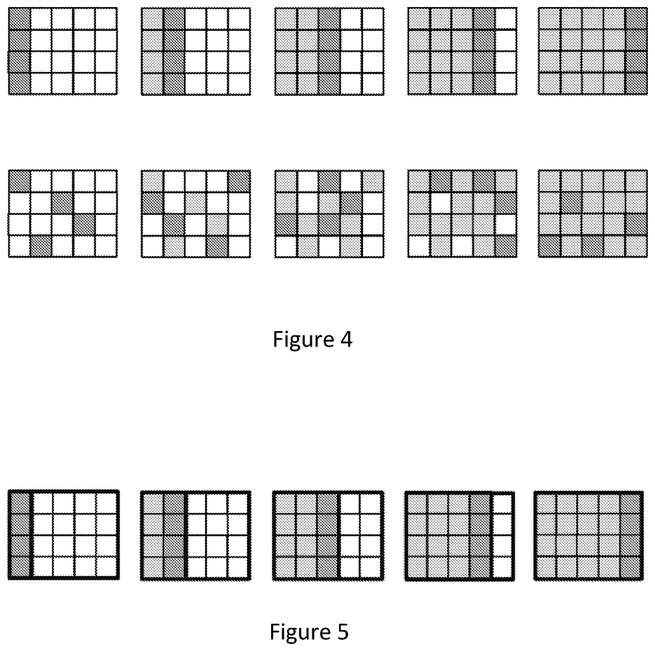

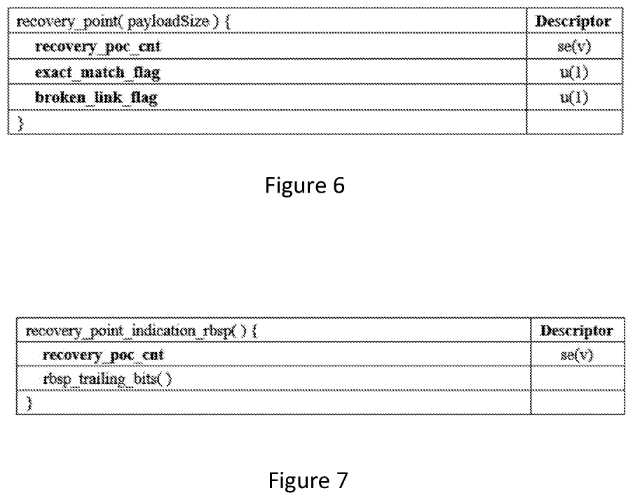

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

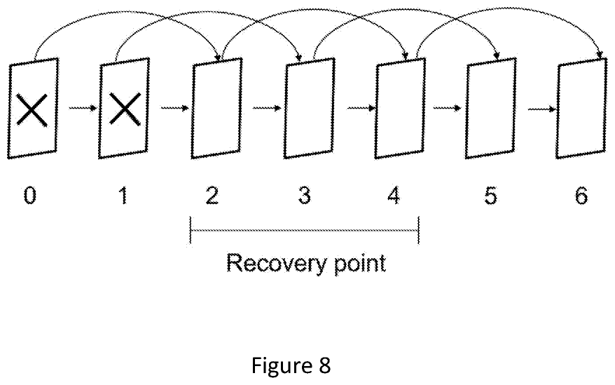

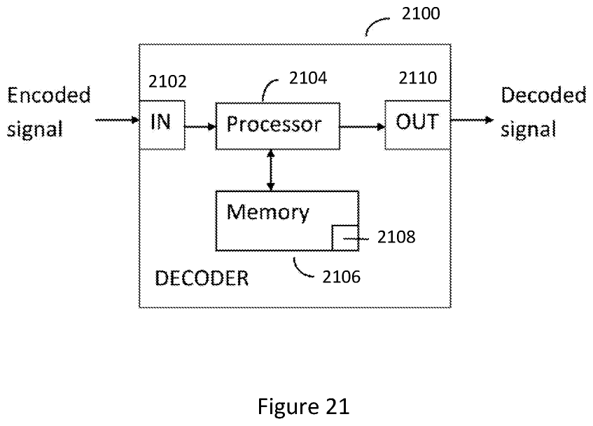

As discussed herein. various embodiments apply to controllers in an encoder and a decoder, as illustrated in FIGS. 8-23. FIG. 21 is a schematic block diagram of a decoder according to some embodiments. The decoder 2100 comprises an input unit 2102 configured to receive an encoded video signal. FIG. 21 illustrates that the decoder is configured to decode a set of pictures in a bitstream, according to various embodiments described herein. Further, decoder 2100 comprises a processor 2104 (also referred to herein as a controller or processor circuit or processing circuitry) for implementing various embodiments described herein. Processor 2104 is coupled to the input (IN) and a memory 2106 (also referred to herein as a memory circuit) coupled to the processor 2104. The decoded and reconstructed video signal obtained from processor 2104 is outputted from the output (OUT) 2110. The memory 2106 may include computer readable program code 2108 that when executed by the processor 2104 causes the processor to perform operations according to embodiments disclosed herein. According to other embodiments, processor 2104 may be defined to include memory so that a separate memory is not required.

Processor 2104 is configured to decode a set of pictures from a bitstream. Processor 2104 may identify a recovery point in the bitstream from a recovery point indication. The recovery point may specify a starting position in the bitstream for decoding the set of pictures. The set of pictures may include a first picture that follows the recovery point indication in a decoding order in the set of pictures, and the set of pictures may include coded picture data. Processor 2104 may decode the recovery point indication to obtain a decoded set of syntax elements. The recovery point indication may include a set of syntax elements. Processor 2104 may derive information for generating a set of unavailable reference pictures from the decoded set of syntax elements before any of the coded picture data is parsed by the decoder. Processor 2104 may generate the set of unavailable reference pictures based on the derived information, and may decode the set of pictures after generation of the set of unavailable reference pictures. Moreover, modules may be stored in memory 2106, and these modules may provide instructions so that when instructions of a module are executed by processor 2104, processor 2104 performs respective operations (e.g., operations discussed below with respect to Example Embodiments relating to decoders).

The decoder with its processor 2104 may be implemented in hardware. There are numerous variants of circuitry elements that can be used and combined to achieve the functions of the units of the decoder. Such variants are encompassed by the various embodiments. Particular examples of hardware implementation of the decoder is implementation in digital signal processor (DSP) hardware and integrated circuit technology, including both general-purpose electronic circuitry and application-specific circuitry.

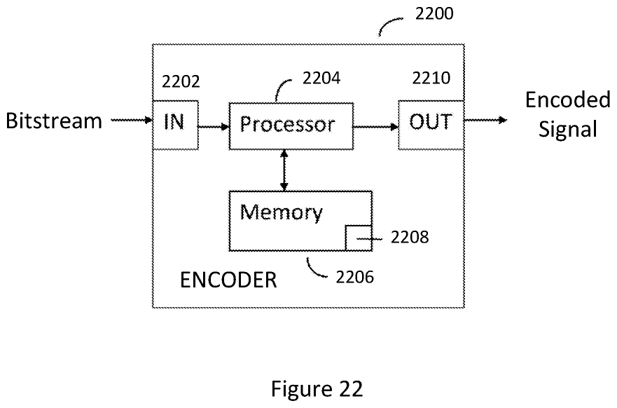

FIG. 22 is a schematic block diagram of an encoder according to some embodiments. The encoder 2200 comprises an input unit 2202 configured to transmit an encoded video signal. FIG. 22 illustrates that the encoder is configured to encode a set of pictures in a bitstream, according to various embodiments described herein. Further, encoder 2200 comprises a processor 2204 (also referred to herein as a controller or processor circuit or processing circuitry) for implementing various embodiments described herein. Processor 2204 is coupled to the input (IN) and a memory 2206 (also referred to herein as a memory circuit) coupled to the processor 2204. The encoded video signal from processor 2204 is outputted from the output (OUT) 2210. The memory 2206 may include computer readable program code 2208 that when executed by the processor 2204 causes the processor to perform operations according to embodiments disclosed herein. According to other embodiments, processor 2204 may be defined to include memory so that a separate memory is not required.

Processor 2204 is configured to encode a recovery point indication with information of how to generate unavailable reference pictures in a bitstream. Processor 2204 may encode a first set of pictures to the bitstream. Processor 2204 may determine a set of reference pictures that would be unavailable to a decoder if decoding started in the bitstream after the first set of pictures. Processor 2204 may encode a recovery point indication to the bitstream. The recovery point indication may include a set of syntax elements for the set of reference pictures. Processor 2204 may encode a second set of pictures to the bitstream. At least one picture in the second set of pictures may reference a picture from the first set of pictures. Moreover, modules may be stored in memory 2206, and these modules may provide instructions so that when instructions of a module are executed by processor 2204, processor 2204 performs respective operations (e.g., operations discussed below with respect to Example Embodiments relating to decoders).

The encoder with its processor 2204 may be implemented in hardware. There are numerous variants of circuitry elements that can be used and combined to achieve the functions of the units of the decoder. Such variants are encompassed by the various embodiments. Particular examples of hardware implementation of the encoder is implementation in digital signal processor (DSP) hardware and integrated circuit technology, including both general-purpose electronic circuitry and application-specific circuitry.

Intra random access point picture (IRAP) pictures will now be discussed. A coded picture which does not reference other pictures than itself for prediction. This means that the coded picture contains only Intra coded block. An IRAP picture may be used for random access.

Recovery points will now be discussed. A recovery point may be a position in the bitstream where a random-access operation can be performed without the presence of any IRAP picture.

Recovery point periods will now be discussed. A recovery point period may be the period of the recovery point, e.g., the period from the first picture where the refresh is started until the last picture where the video is fully decoded when a recovery point random access operation is performed.

A gradual decoding refresh (GDR) picture may be the first picture in a recovery point period. The refresh is starting at this picture. A recovery point random access operation starts by decoding this first picture. The term recovery point begin (RPB) picture is also used interchangeably with GDR picture in this description.

A recovery point picture may be the last picture in the recovery point period. When this picture, the GDR picture and the previous pictures in the recovery point period have been decoded, the video is fully refreshed.

In some embodiments of inventive concepts, a recovery point indication as described in this disclosure may include 1) where the recovery point period begins, e.g. the position of the GDR picture where the refresh is initiated, and 2) where the recovery point period ends, e.g. identification or position of the recovery point picture, where the video has been fully refreshed. In some embodiments, the position of the GDR picture can be explicitly signaled, for example by syntax elements of a picture or syntax elements included in the access unit of the picture. In some embodiments, it is preferred that the recovery point indication is signaled at the position of the GDR picture in the bitstream and that the position of the recovery point picture is explicitly signaled together with the recovery point indication.

The position of the recovery point picture may be signaled by information sent with the GDR picture or in the access unit of the GDR picture, for example by signaled information such that a decoder can derive an ID for the recovery point picture when the GDR picture or the GDR access unit is decoded. The decoder may then check for a match with the ID while decoding pictures that follow the GDR picture in decoding order and the picture with a match is identified as the recovery point picture. The derived ID may be a frame number, a picture order count number, a decoding order number, or any other number that a decoder derives for decoded pictures and may act as a picture identifier.

When tuning in to a bitstream at a recovery point, i.e. performing a random access to the bitstream or if the bitstream starts with a recovery point, the decoder first locates a normative recovery point indication in the bitstream. Since it is known by the encoder that the decoder shall support recovery points, the bitstream can be encoded with recovery points as the only type of random-access points, which will enable random access operations while fulfilling low-delay requirements at the same time. After the recovery point indication has been located, the start and end of the recovery point period is identified before the pictures in the recovery point period are decoded starting from the GDR picture. The pictures in the recovery point period should not be output, except for the recovery point picture. From the recovery point picture and onwards, pictures are decoded and output as normal.

In another embodiment, the recovery point picture is the last picture in decoding order that is not output. In this case, the decoder does not output any picture in the recovery point period, including the recovery point picture, but starts outputting pictures that follow the recovery point picture in decoding order. Here, the recovery point picture may not be fully refreshed and the picture the follows the recovery point picture may be fully refreshed.

When the decoder tunes in to a bitstream at a recovery point, pictures referenced by the pictures in the recovery point period may not be available, if they are located before the recovery point indication in decoding order, see the figure below. Generation of an unavailable picture may comprise allocating memory for a picture, setting block sizes in that picture to specific values, setting the POC value of that picture to a specific value, etc. When generating an unavailable reference picture each value in the sample array of the picture may be set to a specific value, for instance a mid-gray color, and each prediction mode of the reference picture could be set to be mode intra.

FIG. 8 illustrates an example of a reference structure for low-delay video in accordance with inventive concepts. Referring to FIG. 8, pictures 2-4 are included in a recovery point period associated with a recovery point, where picture 2 is the GDR picture and picture 4 is the recovery point picture. If the decoding is started at the recovery point, pictures 0 and 1 referenced by the pictures in the recovery point period are unavailable and needs to be generated.

In an approach proposed in JVET-M0529, generation of reference pictures can only be done when it is known what reference pictures should be present in the RPS. This is derived when the slice header (for HEVC) or tile group header (for the draft VVC) is decoded. This means that generation of reference pictures cannot be done before the slice header or the tile group header is received.

In some embodiments of the present disclosure, the approach discussed above proposed in JVET-M529 may be improved upon by adding information to the recovery point NAL unit such that the information in the recovery point NAL unit is sufficient for generating the necessary reference pictures for recovery point random access.

In some embodiments, generation of reference pictures may be performed early. Instead of waiting for a slice or tile group NAL unit to be received and parsed, a decoder may generate the reference pictures when a recovery point NAL unit has been received and parsed.

In some embodiments, the generation of reference pictures in that a decoder may be simplified. The decoder may first decode the recovery point NAL unit, secondly prepare the decoder by allocating the necessary reference pictures and thirdly may decode the RPB picture without any need to know whether the RPB picture should be treated as a random-access picture or not. The approach discussed above regarding JVET-M0529 is more complicated since a decoder would first decode the recovery point NAL unit, secondly decode the slice or tile group header of the RPB picture, thirdly allocate the reference pictures and fourthly decode the remaining coded slice data for the RPB picture. Since allocation of reference pictures is done when the RPB NAL unit is decoded, the decoder needs to know whether the RPB picture should be treated as a random-access picture or not.

In some embodiments, the number of lines needed in a specification to describe the decoding process may be significantly less than the number of lines needed for the approach described in JVET-M0529.

An exemplary embodiment of inventive concepts, Embodiment 1, will now be discussed regarding generation and initialize of a set of unavailable reference pictures before decoding any picture data. In this embodiment, the generation and initialization of unavailable reference pictures is done before the decoding of any picture data is started. This is in contrast to JVET-M0529 where the generation and initialization is done after parsing of a VCL NAL unit of the RPB picture has started. This is done in JVET-M0529 since the generation and initialization of the unavailable reference pictures depend on information from the header in the VCL NAL unit. The header in the VCL NAL unit is here a segment header such as a slice header, a tile group header or similar. In JVET-M0529, the generation of unavailable reference pictures is based on deriving a set of picture identifiers that are referenced by the RPB picture and are signaled in the slice or tile group header of the RPB picture. In this embodiment, the generation of unavailable reference pictures is based on explicit signaling of all necessary properties of the reference pictures to generate, where the explicit signaling is separate from signaling of the set of picture identifiers that are referenced by the RPB picture and where the explicit signaling is positioned earlier in decoding order than the signaling of the reference picture identifiers for the RPB picture. In the preferred version of this embodiment the set of unavailable reference pictures to generate includes all the reference pictures signaled in the RPL of the RPB picture.

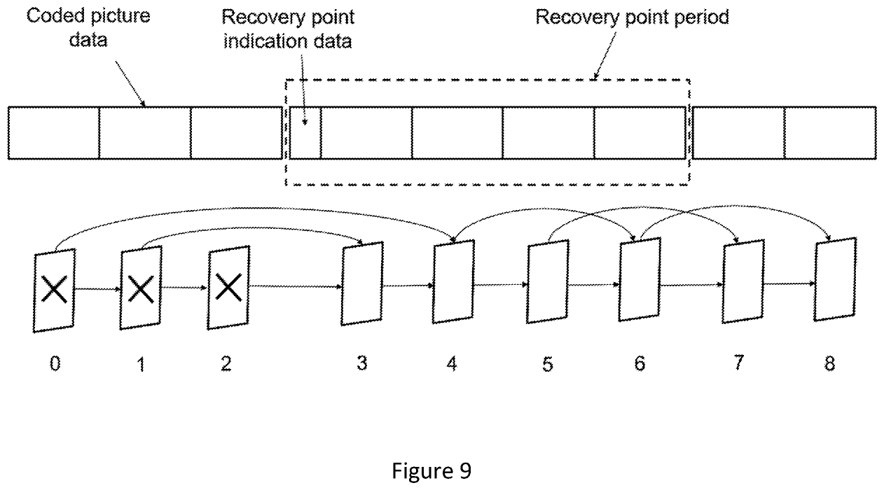

The generation of unavailable reference pictures from information in the recovery point indication data, according to some embodiments, is illustrated in FIG. 9 where the set of blocks in the top part of the figure illustrates a coded video bitstream. FIG. 9 illustrates generation of unavailable reference pictures from information in the recovery point indication data according to some embodiments of inventive concepts. Each large block is coded picture data and the small block is the recovery point indication data that includes syntax elements with information of how to generate and initialize the unavailable reference pictures referenced by the pictures in the associated recovery point period. The recovery point period is marked with a dashed rectangle. An example reference structure of the pictures is illustrated in the bottom part of the figure. The recovery point period contains the recovery point indication and pictures 3, 4, 5 and 6, where picture 3 is the RPB picture. When performing a random access at the recovery point indication, the reference pictures 0, 1 and 2 are not available to the decoder. These unavailable reference pictures are generated and initialized using information in the recovery point indication data. In the preferred version of this embodiment, all unavailable reference pictures are generated and initialized before starting the decoding of the RPB picture (picture 3 in the example). The generation and initialization is done before any data of the RPB picture is parsed by the decoder. Note that also picture 0, which is not referenced by the RPB picture but by picture 4 in the recovery point period, is generated and initialized before starting the decoding of the RPB picture in the preferred version of this embodiment. For the current version of the VVC draft, all of pictures 0, 1 and 2 would be signaled in the reference picture list (RPL) in the tile group header(s) of picture 3.

In some embodiments of inventive concepts, a decoder may perform the following operations for performing a random-access operation on a bitstream:
1. Identify and decode a recovery point indication in the bitstream comprising a set S of recovery point indication syntax elements.
2. Then derive information for generating and initializing a set of unavailable reference pictures from the set S and generate and initialize a set of unavailable reference pictures based on the information.
3. After generation and initializing the set of unavailable reference pictures, start decoding the first coded picture that follows the recovery point indication in decoding order.
4. Then decode the pictures that follows the first coded picture in decoding order.

In some embodiments of inventive concepts, an encoder may perform the following operations for encoding a recovery point indication with information of how to generate unavailable reference pictures in a bitstream:
1. Encode a first set of pictures to a bitstream.
2. Determine a set of reference pictures that would be unavailable to a decoder if the decoding would be started after the first set of pictures.
3. Encode a recovery point indication that includes syntax elements for the reference pictures, to the bitstream.
4. Encode a second set of pictures to the bitstream, where at least one picture in the second set of pictures reference a picture from the first set of pictures.

Another exemplary embodiment in accordance with inventive concepts, Embodiment 2, relating to contents of recovery point indication syntax elements is now discussed. The contents of the set S of recovery point indication syntax elements are discussed and related operations that may be performed.

A parameter set indication is now discussed. In some embodiments, the set S may contain one or more syntax elements specifying at least one parameter set identifier. The decoder would decode the parameter set identifier and use the identifier to identify a parameter set P by comparing the decoded parameter set identifier with the parameter set IDs that are associated with decoded and stored parameter sets. The parameter set P may have been decoded before the set S is decoded or parsed. The decoder may then use information from the parameter set P to generate and initialize the unavailable reference pictures. This information may include e.g. the bit-depth, the chroma subsampling type such as 4:4:4 and 4:2:0, and the picture width and height.

In some embodiments, there may also be links of multiple parameter sets. Using HEVC as a non-limited example, the decoder may have stored multiple picture parameter sets and sequence parameter sets (PPS and SPS), each having a separate ID value. The set S may contain a PPS value that is used to identify the stored PPS having a matching ID. The PPS may contain an SPS identifier value and the decoder may use that to identify the stored SPS having a matching ID. The decoder may then use information from the identified SPS to generate and initialize the unavailable reference pictures.

A number of unavailable reference pictures is now discussed. In some embodiments, the set S may contain one or more codewords specifying the number N of unavailable reference pictures to generate and initialize. The decoder would decode this number and generate and initialize that number of reference pictures. The set S may contain other code words that occur N times in the set S where each value of these other code words may specify a property for the associated unavailable reference picture. For example, there may be a code word in S specifying that there are 2 unavailable reference pictures. In this example, the set S then also contains two occurrences of a picture type code word where the first occurrence may specify the picture type of the first unavailable reference picture and the second occurrence may specify the picture type of the second unavailable reference picture.

An explicit picture order count value for each unavailable reference picture is now discussed. In some embodiments, a set S may contain one or more syntax elements specifying an explicit picture order count value for each unavailable reference picture. This is preferably combined with the number of unavailable reference pictures such that the set S first may specify the number N of unavailable pictures and then contains one explicit picture order count value for each of the N pictures. The decoder may assign the explicit picture order count value to the corresponding unavailable reference picture, for example by setting a variable PicOrderCntVal of the corresponding unavailable picture to the value of the explicit picture order count value decoded from the set S.

In some embodiments, the explicit picture order count value may be signaled in the set S as a signed UVLC value. Alternatively, the explicit picture order count value may be signaled as a combination of two code words where one first code word may specify the X least significant bits of the explicit picture order count value and one second code word may specify the Y most significant bits. The derived explicit picture order count value may then be equal to X+Y*2\hat{ }z where X is a fixed length code word with length z. Additionally there may be a third code word of one bit to specify the sign of the derived explicit picture order count value.

Deriving picture order count values for each unavailable reference picture from the picture order count value of the GDR picture is now discussed. In some embodiments, the set S may contain one or more syntax elements specifying an explicit picture order count value for the GDR picture, for example, according to any of the methods discussed above regarding explicit picture order count value for each unavailable reference picture. Then the set S contains one or more code words for each unavailable reference picture that represents delta picture order count values. The decoder then derives the picture order count value for a particular unavailable reference picture by adding the corresponding delta picture order count value with the picture order count value for the GDR picture. The delta picture order count may be signaled similar to any method for signaling the explicit picture order count value, for example, discussed above regarding explicit picture order count value for each unavailable reference picture.

Picture marking of each unavailable reference picture is now discussed. In some embodiments, the set S may contain one or more syntax elements specifying a picture marking value for each unavailable reference picture. The picture marking value may indicate whether the corresponding unavailable reference picture is a short-term reference picture or a long-term reference picture. Optionally, the picture marking may alternatively indicate the corresponding unavailable reference picture is a picture that is unused for prediction.

In some embodiments, the decoder may mark the corresponding unavailable reference picture with the marking value derived from S. The decoder may store the corresponding unavailable reference picture as being marked with the marking value derived from S in the decoded picture buffer.

Common width and height of unavailable reference pictures is now discussed. The set S may contain one or more syntax elements specifying one picture width and one picture height value. The values may be a width and a height value in luma samples. In some embodiments, the decoder may generate and initialize all unavailable reference pictures to have a picture width and height that is equal to the derived width and height value from S. Separate width and height of each unavailable reference picture is now discussed. In some embodiments, the set S may contain one or more syntax elements specifying a separate width value and a separate height value for each unavailable reference picture. The values may be a width and a height value in luma samples. The decoder may generate and initialize a particular unavailable reference picture to have a picture width and height that is equal to the corresponding derived width and height values.

A number of components and their characteristics is now discussed. In some embodiments, the set S may contain one or more codewords specifying the number M of components that the unavailable reference pictures to generate and initialize include. The set S may contain one or more codewords that specify the relative dimensions of the components of the unavailable reference pictures such as e.g. the chroma subsampling type or the chroma array type. The set S may contain one or more code words that specify the bit-depths of the components.

In some embodiments, the decoder may generate and initialize a particular unavailable reference picture to have a picture having the number M of specified components. The decoder may derive the dimensions of one or more components from the codewords in S that specify the relative dimensions of the components, for example by combining that information with the width and height of one particular component (such as a luma component) signaled elsewhere.

Picture types are now discussed. In some embodiments, the set S may contain one or more syntax elements specifying a picture type value for each unavailable reference picture. The decoder may assign the picture type value to the corresponding unavailable reference picture, for example by setting a picture type variable of the corresponding unavailable picture to the value of the picture type value decoded for that unavailable picture from the set S.

In some embodiments, the picture type value may be one of the following non-limiting examples: A trailing picture, a non-STSA trailing picture, an STSA picture, a leading picture, a RADL picture, a RASL picture, an IDR picture, a CRA picture.

A temporal ID is now discussed. In some embodiments, the set S may contain one or more syntax elements specifying a temporal ID value for each unavailable reference picture. The decoder may assign the temporal ID value to the corresponding unavailable reference picture, for example by setting a temporal ID variable of the corresponding unavailable picture to the value of the temporal ID value decoded for that unavailable picture from the set S.

A layer ID is now discussed. In some embodiments, the set S may contain one or more syntax elements specifying a layer ID value for each unavailable reference picture. The decoder may assign the layer ID value to the corresponding unavailable reference picture, for example by setting a layer ID variable of the corresponding unavailable picture to the value of the layer ID value decoded for that unavailable picture from the set S.

Picture parameter set (PPS) ID for each unavailable reference picture is now discussed. In some embodiments, the set S may contain one or more syntax elements specifying a picture parameter set identifier for each unavailable reference picture. The decoder may assign the picture parameter set identifier to the corresponding unavailable reference picture, for example by setting a picture parameter set identifier variable of the corresponding unavailable picture to the value of the picture parameter set identifier value decoded for that unavailable picture from the set S.

In some embodiments, there may be at least two unavailable reference pictures P1 and P2 such that the set S contains two corresponding picture parameters set identifiers I1 and I2 where the values of I1 and I2 are different. This means that picture P1 is associated with one PPS and picture P2 is associated with another different PPS.

A block size is now discussed. In some embodiments, the set S may contain one or more syntax elements specifying a block size such as a luma size of a coding tree unit and/or a chroma size of a coding tree unit.

In some embodiments, the decoder may assign the block size value to the corresponding unavailable reference pictures, for example by setting a block size variable for each of the unavailable pictures to the value of the decoded block size value. The decoder may generate and initialize at least one unavailable reference picture to have a block size that is equal to the corresponding derived block size value from S. The decoder may derive the number of blocks in an unavailable reference picture from the size of the picture and the block size value of the picture and assign at least one value such as an Intra mode for each block in the unavailable reference picture.

Another exemplary embodiment in accordance with inventive concepts, Embodiment 3, relating to, e.g., a recovery point indication NAL unit is now discussed. In some embodiments, the presence of a recovery point is indicated by a recovery point indication NAL unit and the set S of recovery point indication syntax elements is located in the payload of the recovery point indication NAL unit.

In some embodiments, the indication is based on the presence of a recovery point indication NAL unit such that if a recovery point indication NAL unit is present, a recovery point is indicated. If a recovery point indication NAL unit is not present, a recovery point is not indicated. The recovery point is preferably indicated using a non-VCL NAL unit type, meaning that the NAL unit does not contain any video coding layer data.

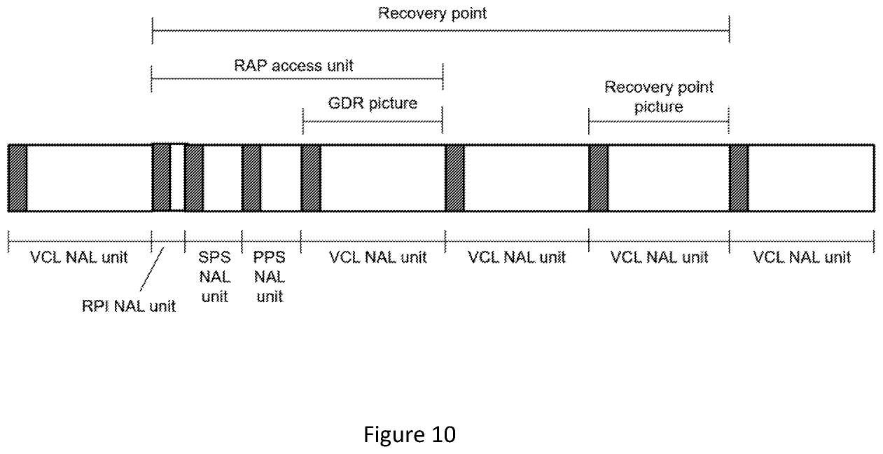

FIG. 10 illustrates an example according to some embodiments of inventive concepts of using a recovery point indication (RPI) NAL unit to indicate a recovery point in a bitstream according to some embodiments of inventive concepts. Referring to FIG. 10, an example bitstream with recovery point indication NAL unit is shown. NAL unit headers are marked in gray.

FIG. 10 illustrates an example according to some embodiments of inventive concepts of using a recovery point indication (RPI) NAL unit to indicate a recovery point in a bitstream. In this example, the bitstream contains one VCL NAL unit per picture, e.g. one slice or one tile group per picture. The recovery point indication NAL unit is placed before the VCL NAL unit containing the GDR picture that begins the refresh. In a preferred version of this embodiment, the recovery point indication NAL unit is placed before any SPS and PPS in the access unit in case there is any SPS or PPS in the access unit. In other versions of the embodiment the SPS and/or PPS is placed before the recovery point indication in the access unit or signaled out-of-band. The recovery point indication NAL unit may preferably be located before any VCL NAL unit in the access unit associated with the GDR picture. This access unit may be referred to as a recovery point access unit or a recovery point begin (RPB) access unit. It may also, as in the example in 10, be referred to as a random-access point (RAP) access unit. The set S of recovery point indication syntax elements is located in the payload of the recovery point indication NAL unit, indicated by “RPI NAL unit” in 10.

Discussed below are example descriptions, syntax and semantics of how the recovery point indication could be specified as a NAL unit type on top of the latest VVC draft according to some embodiments of inventive concepts.

In some embodiments of inventive concepts, a decoder may perform the following operations for performing a random-access operation on a bitstream:
1. Identify and decode a recovery point indication NAL unit in the bitstream comprising a set S of recovery point indication syntax elements.
2. Derive information for generating and/or initializing a set of unavailable reference pictures from the set S.
3. Generate a set of unavailable reference pictures based on the information.
4. Initialize the set of unavailable reference pictures based on the information.
5. After generation and/or initializing the set of unavailable reference pictures, start decoding the first coded picture that follows the recovery point indication in decoding order.
6. Then decode the pictures that follows the first coded picture in decoding order.

Below is an example description, syntax and semantics of how some embodiments of inventive concepts may be specified on top of Versatile Video Coding (Draft 4) WET-M1001-v1. Changes in accordance with some embodiments of inventive concepts are underlined.
3.18 coded video sequence (CVS): A sequence of access units that consists, in decoding order, of an IRAP access unit or an RPB access unit, followed by zero or more access units that are not IRAP access units, including all subsequent access units up to but not including any subsequent access unit that is an IRAP access unit.
3.74 recovery point: A point in the bitstream where the next bit in the bitstream is the first bit of a RPB access unit.
3.75 recovery point begin (RPB) access unit: An access unit that contains a recovery point indication NAL unit.
3.76 recovery point begin (RPB) picture: The coded picture in an RPB access unit.
3.77 recovery point period: The set of pictures including an RPB picture and all pictures that follow the RPB picture until and including the recovery point picture indicated by the recovery point indication NAL unit in the access unit containing the RPB picture.
3.78 recovery point picture: The last coded picture in decoding order in a recovery point period.

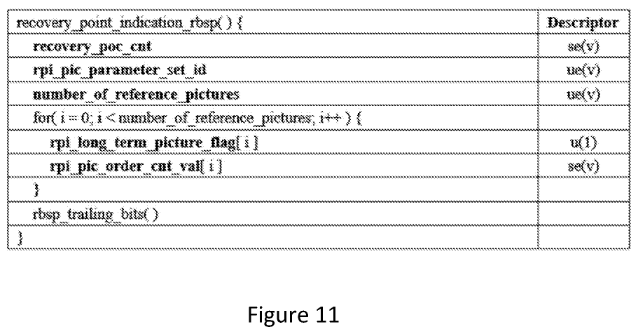

A section “7.3.2.5 Recovery point indication RB SP syntax” may be added on top of JVET-M1001-v1 as shown, e.g., in FIG. 11 of this disclosure in accordance with some embodiments of inventive concepts.

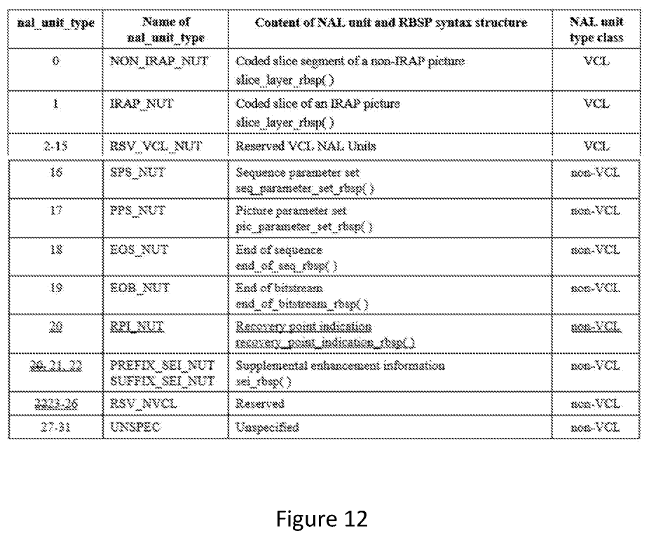

A section “7.4.2.2 NAL unit header semantics” may be added on top of JVET-M1001-v1 as shown, e.g., in FIG. 12 of this disclosure in accordance with some embodiments of inventive concepts. Changes in accordance with some embodiments of inventive concepts are underlined.

In some embodiments of inventive concepts, when nal unit type is equal to RPI NUT, TemporalId shall be equal to 0.

Recovery Point Indication RBSP semantics in accordance with some embodiments of inventive concepts will now be discussed.

In some embodiments of inventive concepts, the RPI NAL unit shall precede any VCL NAL units in the access unit containing the RPI NAL unit. The RPI NAL unit shall follow any SPS or PPS NAL units in the access unit containing the RPI NAL unit. All VCL NAL units in an access unit containing the RPI NAL unit shall have TemporalId equal to 0.

In some embodiments, if an RPB access unit containing an RPI NAL unit is not the first access unit in the CVS and a random access operation is not initialized at the RPB access unit, the RPI NAL unit in the RPB access unit shall be ignored.

In some embodiments, otherwise, if an RPB access unit containing an RPI NAL unit is the first access unit in the CVS or a random access operation is initialized at the RPB access unit, the following applies:
The decoder shall generate unavailable reference pictures according to the process described in 8.2.2.
The poc_msb_cycle_val for the RPB picture shall be set to 0 when deriving the PicOrderCntVal for the RPB picture.
The RPB picture and all pictures that follow the RPB picture in decoding order shall be decoded.
The RPB picture and all pictures that follow the RPB picture in decoding order until but not including the recovery point picture, should not but may be output.
Any SPS or PPS RBSP that is referred to by the picture in a RPB access unit or by any picture following that picture in decoding order shall be available to the decoding process prior to its activation.

In some embodiments of inventive concepts, it may be a requirement of bitstream conformance that the decoded pictures that follow the recovery point picture in decoding order shall be an exact match to the pictures that would be produced by starting the decoding process at the location of an IRAP or RPB access unit that precedes the RPB picture that belong to the same recovery point period as the recovery point picture in decoding order, if any, in the bitstream. In some embodiments of inventive concepts:

recovery_poc_cnt may specify picture order count of the recovery point picture. The picture that follows the current picture in decoding order that has PicOrderCntVal equal to the PicOrderCntVal of the current picture plus the value of recovery_poc_cnt is referred to as the recovery point picture. The recovery point picture shall not precede the current picture in decoding order. The value of recovery_poc_cnt shall be in the range of −MaxPicOrderCntLsb/2 to MaxPicOrderCntLsb/2−1, inclusive.
rpi_pic_parameter_set_id may specify the value of pps_pic_parameter_set_id for the PPS in use. The value of rpi_pic_parameter_set_id shall be identical to the value of tile_group_pic_parameter_set_id of the tile group headers of the coded picture in the RPB access unit.
number_of_reference_pictures may specify the number of reference picture that shall be generated if the RPI NAL unit is the first access unit in the CVS or a random access operation is initialized at the RPB access unit.
rpi_long_term_picture_flag[i] equal to 1 may specify that the i'th reference picture is a long-term picture. rpi_long_term_picture_flag equal to 0 may specify that the i'th reference picture is a short-term picture.
rpi_pic_order_cnt_val[i] may specify the PicOrderCntValue of the i'th generated unavailable reference picture.

A decoding process for generating unavailable reference pictures will now be discussed in accordance with some embodiments of inventive concepts.

In some embodiments, this process is invoked for any RPB NAL unit in the bitstream if the corresponding RPB access unit is the first access unit in the CVS or a random access operation is initialized at the RPB access unit.

The following may apply:

The SPS in use is set to the SPS with the value of sps_seq_parameter_set_id equal to the value of pps_seq_parameter_set_id of the PPS with the value of pps_pic_parameter_set_id equal to the value of rpi_pic_parameter_set_id.
For each i in the range of 0 to number_of_reference_pictures−1, inclusive, an unavailable picture is generated and the following applies:
The value of PicOrderCntVal for the generated picture is set equal to rpi_pic_order_cnt_val[i].
A POC lsb value (for the variable tile_group_pic_order_cnt_lsb for the generated picture) is dervied for the generated picture as PicOrderCntVal % MaxPicOrderCntLsb where % is the modulo operation. This may be equivalent to assigning the POC lsb value as equal to the n least significant bits of PicOrderCntVal where n is equal to log 2_max_pic_order_cnt_lsb_minus4+4.
If rpi_long_term_picture_flag[i] is equal to 1, the generated picture is marked as “used for long-term reference”.
If rpi_long_term_picture_flag[i] is equal to 0, the generated picture is marked as “used for short-term reference”.
The variables BitDepthY, BitDepthC and ChromaArrayType is derived for the SPS in use as specified in clause 7.4.3.1.
The variable PicWidthlnLumaSamples is set equal to pic_width_in_luma_samples of the SPS in use.
The variable PicHeightInLumaSamples is set equal to pic height in luma samples of the SPS in use.
The value of each element in the sample array SL for the generated picture is set equal to 1<<(BitDepthY−1).
When ChromaArrayType is not equal to 0, the value of each element in the sample arrays SCb and SCr for the generated picture is set equal to 1<<(BitDepthC−1).
The prediction mode CuPredMode[x][y] is set equal to MODE_INTRA for x=0 . . . PicWidthlnLumaSamples−1, y=0 . . . PicHeightInLumaSamples−1.

A decoder may choose to generate sps_max_dec_pic_buffering number of pictures instead of number_of_reference_pictures given that an sps_max_dec_pic_buffering syntax element is present in the VVC specification.

Another exemplary embodiment in accordance with some inventive concepts, Embodiment 4, relating to, e.g., a method for generating and initializing unavailable reference pictures is now discussed. Some embodiments of inventive concepts may include assigning and/or allocating memory to store values for the unavailable reference pictures, wherein the stored values includes sample values for each component of the pictures.

In some embodiments, the contents of the elements described in example Embodiment 2 may be used to determine the memory size needed to be assigned/allocated for the unavailable reference pictures, generating a picture for each reference picture in the set of unavailable reference pictures and to initialize each of the reference pictures in the set of unavailable reference pictures.

In a preferred version of some embodiments, all unavailable reference pictures are generated and initialized before the decoding of the first coded picture that follows the recovery point indication in decoding order, e.g. the RPB picture.

In some embodiments of inventive concepts, a decoder may perform the following operations to generate and initialize unavailable reference pictures when performing a random-access operation on a bitstream:

1. Identify and decode a recovery point indication in the bitstream comprising a set S of recovery point indication syntax elements.

2. Derive information for generating and/or initializing a set of unavailable reference pictures from the set S.

3. Determine the memory size needed for the unavailable reference pictures, wherein the determining of the memory size comprises at least one of:
The number of unavailable reference pictures
The number of components for each reference picture
The width and height of each component
The bit depth of a sample in each component

4. Assign and/or allocate memory for the unavailable reference pictures based on the determined memory size needed

5. Generate a picture for each reference picture in the set of unavailable reference pictures, wherein the generation comprises at least one of:
Set the number of components for the picture
Set the width and height for each component of the picture
Set the sample bit depth for each component of the picture
Set a sample value for each sample in the picture
Assign a PPS identifier to the reference picture
Assign a SPS identifier to the reference picture
Assign an identifier such as the picture order count value to the reference picture
Mark the reference picture as a short-term picture, as a long-term picture or unused for prediction
Assign a picture type to the reference picture
Assign a temporal ID to the reference picture
Assign a layer ID to the reference picture
Assign a block size for each of the components
Mark each of the generated reference pictures as initialized

Another exemplary embodiment in accordance with some inventive concepts, Embodiment 5, relating to, e.g., recovery point indication in picture header is now discussed. The final version of VVC may include a picture header to efficiently code header data that are identical between tile groups.

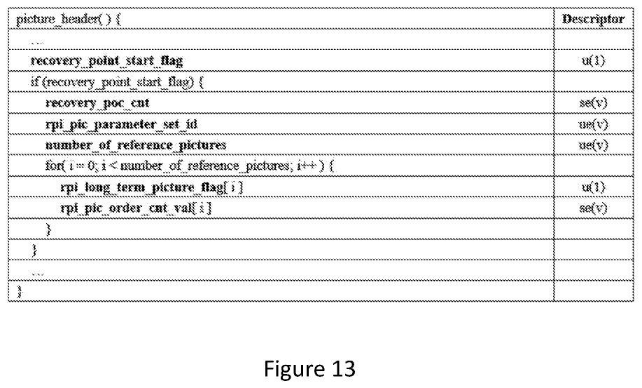

In some embodiments of inventive concepts, the contents of the set S of recovery point indication syntax elements of the recovery point indication is signaled in such a picture header. FIG. 13 shows an example syntax and semantics for this in accordance with some embodiments of inventive concepts. Referring to FIG. 13, recovery_point_start_flag equal to 1 may specify that the current picture is the first picture of a recovery point. The last picture of the recovery point is specified by recovery_poc_cnt. recovery_point_start_flag equal to 0 may specify that the current picture is not the first picture of a recovery point.

In this example according to some inventive concepts, the semantics for recovery_poc_cnt, rpi_pic_parameter_set_id, number_of_reference_pictures, rpi_long_term_picture_flag[i] and rpi_pic_order_cnt_val[i] are the same as described in exemplary Embodiment 3.

A potential drawback with specifying the recovery point indication in a picture header may be that it may not be well exposed to the systems layer. An approach to make it more accessible to the systems layer may be to use fixed length coding for the recovery point syntax and the syntax elements prior to the recovery point syntax and/or put the recovery point syntax elements in the beginning of the picture header.

In some embodiments of inventive concepts, the indication that the current picture is the first picture of a recovery point, recovery_point_start flag in the example above, is signaled by some other means, e.g. as a nal_unit_type in a VCL NAL unit as in exemplary Embodiment 6.

Another exemplary embodiment in accordance with inventive concepts, Embodiment 6, relating to, e.g., recovery point indication as a NAL unit type in a VCL NAL unit is now discussed. In some embodiments of inventive concepts, an indication of the recovery point indication is signaled as a NAL unit type in a VCL NAL unit. In some embodiments, two new NAL unit types may be defined; a picture type NON_IRAP_RPI_BEGIN that indicates the beginning of a recovery point period and a NAL unit type NON_IRAP_RPI_END that indicates the end of the recovery point period.

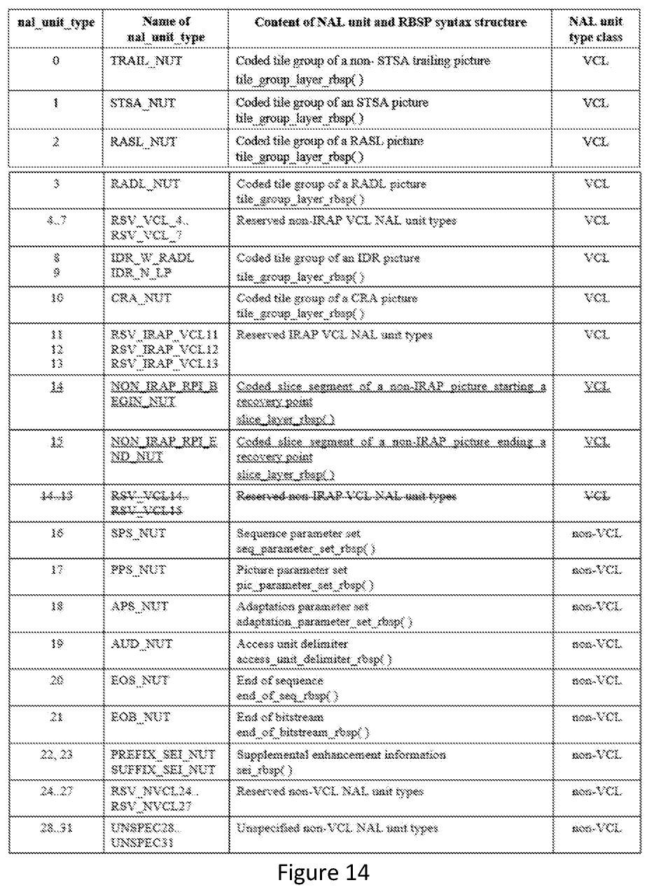

Example specification text on top of the current VVC draft is shown in FIG. 14, in accordance with some embodiments of inventive concepts.

In some embodiments, the POC for the recovery point picture does not need to be explicitly signaled.

To fully support temporal layers, NON_IRAP_RPI_BEGIN_NUT and NON_IRAP_RPI_END_NUT should be restricted to not be set for pictures of different temporal layers.

In some embodiments, a benefit may be provided for easy access of the recovery point information to the systems layer. A potential problem with this approach is that the recovery point indication becomes tied to the picture type. To allow for recovery points in pictures with different picture types, NAL unit types for all combinations or a subset of combinations may be needed. This may include if one would like to support a recovery point starting at the same picture as the previous recovery point period ended. To be able to support overlapping recovery points, a mechanism for mapping the end of a recovery point period to the correct start of a new recovery point may be needed.

In some embodiments of inventive concepts, at least one of the information about the end of the recovery point period, e.g. the POC for the recovery point picture, the contents of the set S of recovery point indication syntax elements and other information related to the recovery point is signaled by other means, such as in a picture header as described in Embodiment 5, in SPS or in PPS as described regarding exemplary Embodiment 7 or in a tile group header. Thus, if the end of the recovery point period is signaled by other means, only the start of the recovery point, NON_IRAP_RPI_BEGIN_NUT, is signaled as a NAL unit type.

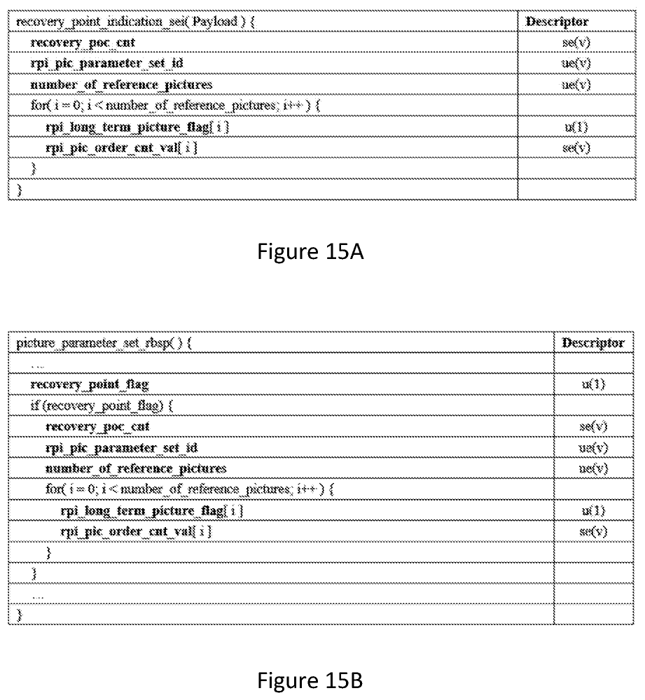

Another exemplary embodiment of inventive concepts, Embodiment 7, relating to, e.g., signaling information about generation of reference pictures in an SEI, in the PPS or in SPS is now discussed. In some embodiments, the contents of the set S of recovery point indication syntax elements of the recovery point indication are signaled in an SEI message. FIG. 15A shows an example syntax for this, in accordance with some embodiments of inventive concepts.

In the example of FIG. 15A, the semantics for recovery_poc_cnt, rpi_pic_parameter_set_id, number_of_reference_pictures, rpi_long_term_picture_flag[i] and rpi_pic_order_cnt_val[i] are the same as described regarding exemplary Embodiment 3.

In another embodiment, the contents of the set S of recovery point indication syntax elements of the recovery point indication is signaled in the SPS or PPS. FIG. 15B shows an example syntax for signaling the set S of recovery point indication syntax elements in PPS, in accordance with some embodiments of inventive concepts. In this exemplary embodiment, the semantics for recovery_poc_cnt, rpi_pic_parameter_set_id, number_of_reference_pictures, rpi_long_term_picture_flag[i] and rpi_pic_order_cnt_val[i] are the same as described regarding exemplary Embodiment 3.

The indication of where the recovery point period begins should preferably be signaled by other means than in a parameter set, since a parameter set may be valid for multiple pictures. The indication of where the recovery point period begins may for instance be signaled as a NAL unit type in the NAL unit header of a picture with an active SPS or PPS containing the additional recovery point information.

Another exemplary embodiment of inventive concepts, Embodiment 8, relating to, e.g., starting a CVS with a recovery point and generate unavailable reference pictures before decoding the RPB picture is now discussed. In some embodiments of inventive concepts, a CVS is started with a recovery point where the unavailable reference pictures are generated and/or initialized before starting to decode the RPB picture of the recovery point period as described in any of the previous or following embodiments.

Defining the recovery point indication in a normative way, as for instance in a non-VCL NAL unit or as a nal_unit_type in a VCL NAL unit, enables a CVS to start with a recovery point. This may be useful after splitting a low-delay coded bitstream encoded with recovery points to support random access.

In the current draft of VVC, a CVS is defined as follows with inventive concepts shown with underling and strikethroughs:

access unit: A set of NAL units that are associated with each other according to a specified classification rule, are consecutive in decoding order, and contain exactly one coded picture. coded video sequence (CVS): A sequence of access units that may include, in decoding order, of an IRAP access unit, followed by zero or more access units that are not IRAP access units, including all subsequent access units up to but not including any subsequent access unit that is an IRAP access unit.

Below is an example text for a definition of a CVS for some embodiments of inventive concepts that allows a normatively specified recovery point to start a CVS, where a recovery point indication access unit is an access unit associated with the GDR picture of the recovery point:

coded video sequence (CVS): A sequence of access units that may include, in decoding order, of an IRAP access unit or a recovery point indication access unit, followed by zero or more access units that are not IRAP access units, including all subsequent access units up to but not including any subsequent access unit that is an IRAP access unit.

In some embodiments of inventive concepts, a recovery point indication access unit also may define the end of a CVS. Example text for a definition of CVS is shown below:

coded video sequence (CVS): A sequence of access units that may include, in decoding order, of an IRAP access unit or a recovery point indication access unit, followed by zero or more access units that are not IRAP access units and not recovery point indication access units, including all subsequent access units up to but not including any subsequent access unit that is an IRAP access unit or a recovery point access unit.

The recovery point indication access unit could also be called something else, for instance GDR access unit, or Recovery Point Begin (RPB) access unit.

In some embodiments of inventive concepts, a random access point (RAP) access unit may be defined, which could comprise either an IRAP picture or the GDR picture of the recovery point:

coded video sequence (CVS): A sequence of access units that may include, in decoding order, of RAP access unit, followed by zero or more access units that are not RAP access units, including all subsequent access units up to but not including any subsequent access unit that is RAP access unit.

random access point (RAP) access unit: An access unit in which the coded picture is an IRAP picture or in which the access unit contains a recovery point indication.

Another exemplary embodiment, Embodiment 9, in accordance with inventive concepts relating to, e.g., recovery point for a spatial subset of the picture is now discussed. In some embodiments of inventive concepts, in contrast to some embodiments discussed above, the scope of the recovery point indication is not the whole picture, but a set of temporally aligned segments of a picture, where a segment could be a tile, a tile group, a slice or similar. Thus, the recovery point indication in this embodiment may specify when one or more segments of a picture are fully refreshed.

In some embodiments, a recovery point indication is signaled right before each segment, for instance in a NAL unit or a segment header.

In another embodiment, the recovery point indication is signaled in the same container, e.g. a NAL unit, a PPS, a SPS or a picture header, for the whole picture but may have a different starting and/or ending picture for the recovery period for each segment.

In another embodiment, the signaled recovery point indication may comprise both a starting and ending picture for the recovery point period of the whole picture and separate starting and/or ending picture for the recovery point period for each segment.

In another embodiments, the recovery point indication comprises a flag to determine if the spatial scope is the whole picture or just a segment in the bitstream.

In another embodiments, when a random access operation is initiated at a recovery point for a segment, only the spatial area of the unavailable reference pictures that are collocated to the segment is generated.

In another embodiments, when a random access operation is initiated at a recovery point for a segment, the full unavailable reference pictures are generated.

Further discussion of exemplary Embodiments 1 through 9 in accordance with inventive concepts is below.

Some embodiments of exemplary Embodiment 1 to generate and initialize a set of unavailable reference picture before decoding any picture data may include:

1. A method for decoding a video bitstream, the video bitstream comprising a coded video sequence (CVS) of pictures containing a recovery point (e.g., at least one recovery point), wherein:

The recovery point is a position in the bitstream where decoding may start at a picture A that contains at least one block that is not an Intra coded block,

A picture B that follows picture A in decoding order is identified,

The video is fully refreshed at picture B if the decoding is started at picture A and the pictures following picture A and preceding picture B in decoding order and picture B, are decoded, and the method comprises:

obtaining (e.g., receiving) the video bitstream;

decoding an indication of the recovery point from the video bitstream;

deriving information for generating and initializing a set of (unavailable) reference pictures by decoding a set of syntax S elements from the bitstream;

generating and initializing the set of reference pictures from the information for generating and initializing a set of reference pictures; and

after generating and initializing the set of reference pictures start decoding picture A

Some embodiments of exemplary Embodiment 2 may include Embodiment 1 where deriving information for generating and initializing a set of reference pictures by decoding a set of syntax S elements from the bitstream comprises deriving (from S) and using one or more of the following information:

1. Deriving at least one parameter set identifier that identifies a parameter set that is active for picture A

2. Deriving the number of reference pictures to generate and initialize

3. Deriving the picture order count value for each of the reference pictures and assigning the derived picture order count values to the associated reference picture

4. Derive the picture order count value of picture A, derive a delta picture order count relative to the picture order count of picture A for each of the reference pictures, and use these derived values to calculate the picture order count values for each of the reference pictures and assign the calculated picture order count values to the associated reference picture

5. Deriving the picture marking status for each of the reference pictures where the picture marking status is one of long-term picture and short-term picture (and optionally an unused for prediction marking status), and mark each reference picture with the derived marking status

6. Derive a luma width value and a luma height value and generate reference pictures having that width and height

7. Derive the a luma width value and a luma height value for each of the reference pictures and generate each of the reference pictures to have the width and height of the associated derived luma width and height value

8. Derive the number of components picture A and the reference may include, the relative dimensions of the components (ChromaArrayType in HEVC) and the bit-depth for each or all components. Generate reference pictures having the number of components, relative dimensions and bit-depth according to the derived values.

9. Derive a picture type value for each of the reference pictures and assign the derived picture type values to the associated reference picture

10. Derive a temporal ID value for each of the reference pictures and assign the derived temporal ID values to the associated reference picture

11. Derive a layer ID value for each of the reference pictures and assign the derived layer ID values to the associated reference picture

12. Derive at least one picture parameter set identifier for each of the reference pictures and assign the derived at least one picture parameter set identifier values to the associated reference picture

13. Derive a block size such as a size of a coding tree unit, generate the reference pictures to have that block size, and assign the block size to the reference pictures

Some embodiments of exemplary Embodiment 3 may include Embodiments 1 and 2 where the set of syntax elements S is decoded from a non-VCL NAL unit having a non-VCL NAL unit type that indicates that the non-VCL NAL unit is a recovery point indication non-VCL NAL unit.

Some embodiments of exemplary Embodiment 4 may include Embodiments 1-3 where generating and initializing a reference picture in the set of reference pictures comprises allocating or assigning memory to store values for the picture, wherein the stored values includes sample values for each component of the picture.

Some embodiments of exemplary Embodiment 4 may further include where generating and initializing a reference picture in the set of reference pictures includes at least one of:
a. Setting the number of components for the picture
b. Setting the width and height for each component of the picture
c. Setting the sample bit depth for each component of the picture
d. Setting a sample value for each sample in the picture
e. Assigning a PPS identifier to the reference picture
f. Assigning a SPS identifier to the reference picture
g. Assigning an identifier such as the picture order count value to the reference picture
h. Marking the reference picture as a short-term picture, as a long-term picture or unused for prediction
i. Assigning a picture type to the reference picture
j. Assigning a temporal ID to the reference picture
k. Assigning a layer ID to the reference picture
l. Assigning a block size for each of the components
m. Marking each of the generated reference pictures as initialized

Some embodiments of exemplary Embodiment 5 may include Embodiments 1-4 where the set of syntax elements S is decoded from a picture header.

Some embodiments of exemplary Embodiment 6 may include Embodiments 1-5 where at least one of indication of start of the recovery point and indication of end of recovery point period is decoded from a NAL unit type syntax element in a VCL NAL unit.

Some embodiments of exemplary Embodiment 7 may include Embodiments 1-6 where the set of syntax elements S is decoded from an SEI message.

Some embodiments of exemplary Embodiment 7 may further include where the set of syntax elements S is decoded from a picture parameter set such as PPS or SPS.

Some embodiments of exemplary Embodiment 8 may include Embodiments 1-7 where the CVS starts with the recovery point.

Some embodiments of exemplary Embodiment 8 may further include where a CVS is a conforming part of a bitstream that conforms to a standard specification such that a decoder that conforms to the standard specification is required to be able to decode the CVS.

Some embodiments of exemplary Embodiment 9 may include Embodiments 1-8 where

the recovery point indication is only valid for a spatial subset of the picture.

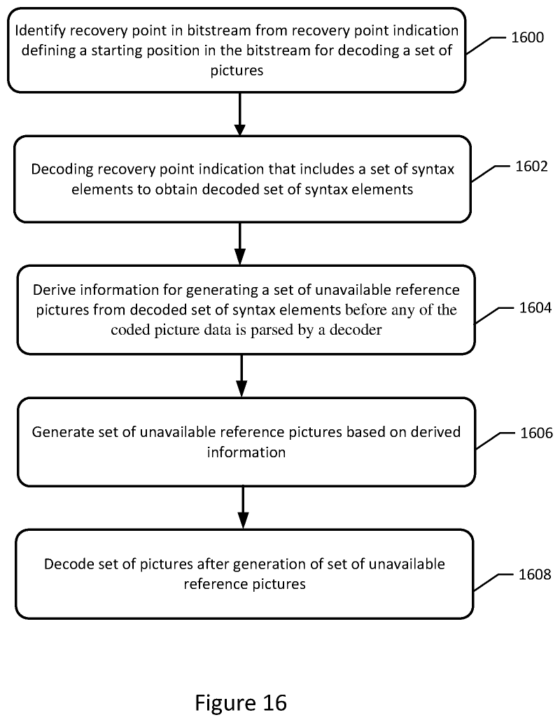

Operations of the decoder 2100 (implemented using the structure of the block diagram of FIG. 21) will now be discussed with reference to the flow chart of FIG. 16 according to some embodiments of inventive concepts. For example, modules may be stored in memory 2106 of FIG. 21, and these modules may provide instructions so that when the instructions of a module are executed by respective wireless device processing circuitry 2104, processing circuitry 2104 performs respective operations of the flow chart.

FIG. 16 illustrates operations of a decoder to decode a set of pictures from a bitstream. The decoder may be provided according to the structure illustrated in FIG. 21.

At block 1600 of FIG. 16, processor 2104 of the decoder identifies a recovery point in the bitstream from a recovery point indication. The recovery point may specify a starting position in the bitstream for decoding the set of pictures. The set of pictures may include a first picture that is the first picture that follows the recovery point indication in a decoding order in the set of pictures and the set of pictures may include coded picture data. Coded picture data includes data carrying coded samples, including headers accompanying the coded samples. Typically, coded picture data refers to coded data that is packetized into data units such as the NAL unit known from e.g. HEVC and the VVC draft specification. Coded picture data may include all data in the data unit or NAL unit carrying coded samples, including headers such as slice headers and/or tile group headers. For example, the coded picture data may include all VCL NAL units in the bitstream while no non-VCL NAL unit may be considered coded picture data. Decoding of coded picture data results in determining a set of sample values of a picture. Decoding of data that is not coded picture data may not result in determining any sample value since that data does not contain any coded samples. A picture header may not be considered coded picture data, especially if the unit in which it is packetized into does not include any coded sample data.

Still referring to block 1600 of FIG. 16, the first picture may include a block that is not an intra coded block. The set of unavailable reference pictures may include at least one unavailable reference picture. The set of pictures also may include at least one picture. The recovery point indication may be preceded by the set of unavailable reference pictures and may be followed by the set of pictures. The set of pictures also may include references to the set of unavailable reference pictures. The set of pictures may include a recovery point period starting at the first picture and ending at a recovery point picture. The recovery point indication may also include specifying an end picture of the recovery point period in the bitstream. The bitstream may start with the starting position in the bitstream specified by the recovery point. The bitstream may include a conforming part of the bitstream that conforms to a standard specification and the decoding decodes the conforming part of the bitstream. The conforming part of the bitstream may be a CVS.

Still referring to block 16 of FIG. 16, the recovery point indication can be valid for a spatial subset of each picture in the set of pictures. The first picture in the set of pictures may be followed by a second picture in the set of pictures, where the first and second pictures are different pictures, and where the second picture follows the first picture in decoding order. The recovery point indication may include a normative indication of the recovery point, and the normative indication of the recovery point may include a temporal position of at least of a first and a second picture in the set of pictures. A normative indication of the recovery point may be ignored if at least one of: the recovery point does not start the bitstream and a random access operation is not performed at the recovery point. The normative recovery point indication may not be contained in a supplemental enhancement information (SEI) message decoded from the set of syntax elements. The recovery point indication and a first picture in the set of pictures may belong to the same access unit. The set of unavailable reference pictures may include all unavailable reference pictures in the bitstream before the first picture in the set of pictures in the decoding order, and the decoding the set of pictures may use the set of unavailable reference pictures for decoding all pictures in the set of pictures in decoding order starting from the first picture in the bitstream in the set of pictures and ending with the second picture in the bitstream in the set of pictures.

At block 1602 of FIG. 16, processor 2104 of the decoder decodes the recovery point indication to obtain a decoded set of syntax elements. The recovery point indication may include a set of syntax elements. The set of syntax elements may include a set of recovery point indication syntax elements. The set of syntax elements may include at least one syntax element. The decoded set of syntax elements is decoded from a recovery point indication in a non-video coding layer (non-VCL) network abstraction layer (NAL) having a non-VCL NAL unit type that indicates that the non-VCL NAL unit is a recovery point indication non-VCL NAL unit. The set of syntax elements may be decoded from a picture header. The recovery point indication may be decoded from a video coding layer (VCL) network abstraction level (NAL) unit including a NAL unit type syntax element. The decoded syntax element may include at least one of: a start position of a recovery point and an end position of the recovery point period. The decoded set of syntax elements may be decoded from a supplemental enhancement information (SEI) message. The decoded set of syntax elements may be decoded from a picture parameter set including at least one of: a picture parameter set (PPS) and sequence parameter set (SPS).

At block 1604 of FIG. 16, processor 2104 of the decoder derives information for generating a set of unavailable reference pictures from the decoded set of syntax elements before any of the coded picture data is parsed by the decoder. Deriving information for generating the set of unavailable reference pictures from the decoded set of syntax elements comprises at least one of:
Deriving at least one parameter set identifier that identifies a parameter set that is active for the first picture in the set of pictures;
Deriving a number of unavailable reference pictures in the set of unavailable reference pictures to generate;
Deriving a picture order count value for each picture in the set of the unavailable reference pictures and assigning a derived picture order count value to each of the associated pictures in the set of unavailable reference pictures;
Deriving a picture order count value for the first picture in the set of pictures, deriving delta values for a delta picture order count for each of the pictures in the set of unavailable reference pictures relative to the picture order count value for the first picture in the set of pictures, and using the derived delta values to calculate a picture order count value for each of the pictures in the set of unavailable reference pictures and assigning the calculated picture order count values to each of the associated unavailable reference pictures;
Deriving a picture marking status for each picture in the set of unavailable reference pictures, wherein the picture marking status is at least one of: a long-term picture, a short-term picture, and a mark each picture in the set of unavailable reference pictures with a derived marking status;
Deriving a luma width value and a luma height value and generating each picture in the set of unavailable reference pictures having the luma width value and the luma height value;
Deriving a luma width value and a luma height value for each picture in the set of unavailable pictures and generating each picture in the set of unavailable reference pictures to have a width and a height of the associated derived luma width and height value;
Deriving a number of components of the unavailable reference pictures comprising a relative dimension value for each of the components and a bit-depth value for each of the components; and generating each picture in the set of unavailable reference pictures having the number of components, the relative dimensions and the bit-depth according to the derived values;
Deriving a picture type value for each picture in the set of unavailable reference pictures and assigning the derived picture type values to each of an associated unavailable reference picture in the set of unavailable reference pictures;
Deriving a temporal identity value for each of the pictures in the set of unavailable reference pictures and assigning the derived temporal identity values to each of an associated unavailable reference picture in the set of unavailable reference pictures;
Deriving a layer identity value for each of the pictures in the set of unavailable reference pictures and assigning a derived layer identity value to each of an associated unavailable reference picture in the set of unavailable reference pictures;
Deriving at least one picture parameter set identifier for each of the pictures in the set of unavailable reference pictures and assigning the derived at least one picture parameter set identifier values to each of an associated unavailable reference picture in the set of unavailable reference pictures; and
Deriving a block size comprising a size of a coding tree unit, generating each picture in the set of unavailable reference pictures to have that block size, and assigning the block size to each of an unavailable reference picture in the set of unavailable reference pictures.

At block 1606 of FIG. 16, processor 2104 of the decoder generates the set of unavailable reference pictures based on the derived information. For example, the generating may be done before any of the coded picture data is parsed by the decoder. Generating the set of unavailable reference pictures may include generating each of the pictures in the set of unavailable reference pictures. Generating the set of unavailable reference pictures from the derived information may include generating the set of unavailable reference pictures before starting the decoding of any picture in the set of pictures. Generating the set of unavailable reference pictures may include allocating or assigning memory to store values for each of the pictures in the set of unavailable reference pictures. The stored values may include sample values for each component of each picture in the set of unavailable reference pictures. Generating each of the pictures in the set of unavailable reference pictures may include at least one of:
Setting a number of components for the picture in the set of unavailable reference pictures;
Setting a width and a height for each component of the picture in the set of unavailable reference pictures;
Setting a sample bit depth for each component of the picture in the set of unavailable reference pictures;
Setting a sample value for each sample in the picture in the set of unavailable reference pictures;
Assigning a PPS identifier to the picture in the set of unavailable reference pictures;
Assigning a SPS identifier to the picture in the set of unavailable reference pictures;
Assigning an identifier to the picture in the set of unavailable reference pictures, wherein the identifier comprises a picture order count value;
Marking the picture in the set of unavailable reference pictures as at least one of: a short-term picture, a long-term picture, and an unused for prediction;
Assigning a picture type to the picture in the set of unavailable reference pictures;
Assigning a temporal ID to the picture in the set of unavailable reference pictures;
Assigning a layer ID to the picture in the set of unavailable reference pictures;
Assigning a block size for each component of the picture in the set of unavailable reference pictures; and
Marking the picture in the set of unavailable reference pictures as initialized.

At block 1608 of FIG. 16, processor 2104 of the decoder decodes the set of pictures after generation of the set of unavailable reference pictures. Decoding the set of pictures after generation of the set of unavailable reference pictures may include a video that is fully refreshed at the recovery point picture if the decoding is started at the first picture and all other pictures in the recovery point period following the first picture and preceding the recovery point picture in the decoding order and including the recovery point picture are decoded.

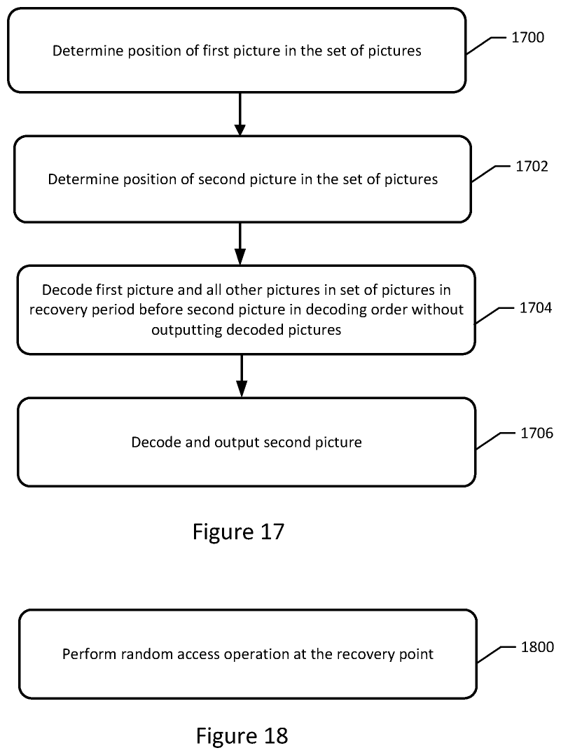

FIG. 17 illustrates additional operations the decoder may perform to decode a set of pictures from a bitstream. The decoder may be provided according to the structure illustrated in FIG. 21.

At block 1700 of FIG. 17, processor 2104 of the decoder, when the decoding the set of pictures is initialized at the recovery point, determines a position of a first picture in the set of pictures.

At block 1702 of FIG. 17, processor 2104 of the decoder determines a position of a second position in the set of pictures.

At block 1704 of FIG. 17, processor 2104 of the decoder decodes the first picture and all other pictures in the set of pictures in the recovery period before the second picture in the decoding order without outputting the decoded pictures.

At block 1706 of FIG. 17, processor 2104 of the decoder decodes and outputs the second pictures.

The various operations from the flow chart of FIG. 17 may be optional with respect to some embodiments of decoders and related methods, for example, operation 1706.

FIG. 18 illustrates additional operations the decoder may perform to decode a set of pictures from a bitstream. The decoder may be provided according to the structure illustrated in FIG. 21. At block 1800 of FIG. 18, processor 2104 of the decoder performs a random access operation at the recovery point.

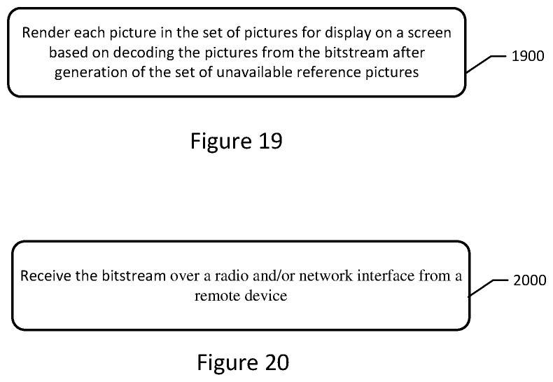

FIG. 19 illustrates additional operations the decoder may perform after decoding a set of pictures from a bitstream. The decoder may be provided according to the structure illustrated in FIG. 21. At block 1900 of FIG. 19, processor 2104 of the decoder renders each picture in the set of pictures for display on a screen based on decoding the pictures from the bitstream after generation of the set of unavailable reference pictures.

FIG. 20 illustrates additional operations the decoder may perform after decoding a set of pictures from a bitstream. The decoder may be provided according to the structure illustrated in FIG. 21. At block 2000 of FIG. 20, processor 2104 of the decoder receives the bitstream over a radio and/or network interface from a remote device.

The various operations from the flow charts of FIG. 18-20 may be optional with respect to some embodiments of decoders and related methods, for example, operations 1800, 1900 and 2000.

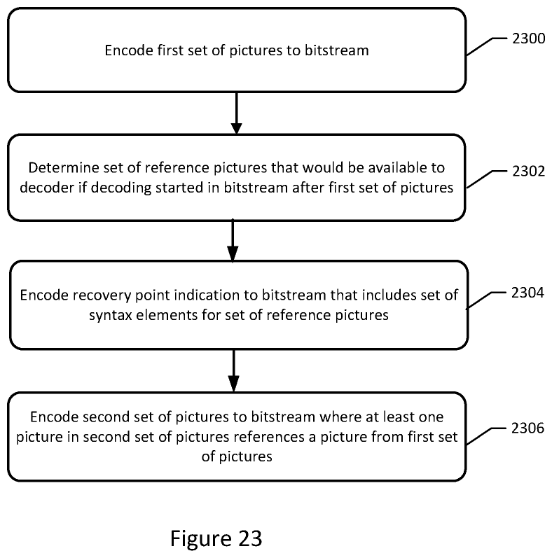

Operations of the encoder 2200 (implemented using the structure of the block diagram of FIG. 22) will now be discussed with reference to the flow chart of FIG. 23 according to some embodiments of inventive concepts. For example, modules may be stored in memory 2206 of FIG. 22, and these modules may provide instructions so that when the instructions of a module are executed by respective wireless device processing circuitry 2204, processing circuitry 2204 performs respective operations of the flow chart.

FIG. 23 illustrates operations of an encoder to encode a recovery point indication with information of how to generate unavailable reference pictures in a bitstream. The encoder may be provided according to the structure illustrated in FIG. 22.

At block 2300 of FIG. 23, processor 2204 of the encoder encodes a first set of pictures to the bitstream. The first set of pictures may include at least one picture.

At block 2302 of FIG. 23, process 2204 of the encoder determines a set of reference pictures that would be unavailable to a decoder if decoding started in the bitstream after the first set of pictures. The set of reference pictures may include at least one reference picture.

At block 2304 of FIG. 23, process 2204 of the encoder encodes a recovery point indication to the bitstream. The recovery point indication may include a set of syntax elements for the set of reference pictures. The set of syntax elements may include at least one syntax element for at least one picture in the set of reference pictures.

At block 2306 of FIG. 23, process 2204 of the encoder encodes a second set of pictures to the bitstream. At least one picture in the second set of pictures may reference a picture from the first set of pictures.

Example embodiments are discussed below. Reference numbers/letters are provided in parenthesis by way of example/illustration without limiting example embodiments to particular elements indicated by reference numbers/letter.

### Embodiment 1

A method of decoding a set of pictures from a bitstream. The method includes identifying (1600) a recovery point in the bitstream from a recovery point indication. The recovery point specifies a starting position in the bitstream for decoding the set of pictures. The set of pictures includes a first picture that is the first picture that follows the recovery point indication in a decoding order in the set of pictures and wherein the set of pictures include coded picture data. The method further includes decoding (1602) the recovery point indication to obtain a decoded set of syntax elements. The recovery point indication includes a set of syntax elements. The method further includes deriving (1604) information for generating a set of unavailable reference pictures from the decoded set of syntax elements before any of the coded picture data is parsed by a decoder. The method further includes generating (1606) the set of unavailable reference pictures based on the derived information. The method further includes decoding (1608) the set of pictures after generation of the set of unavailable reference pictures.

### Embodiment 2

The method of Embodiment 1, wherein the generating is done before any of the coded picture data is parsed by the decoder.

### Embodiment 3

The method of any of Embodiments 1 to 2, wherein the first picture includes a block that is not an intra coded block.

### Embodiment 4

The method of any of Embodiments 1 to 3, wherein the set of unavailable reference pictures includes at least one unavailable reference picture and wherein generating a set of unavailable reference pictures includes generating each of the pictures in the set of unavailable reference pictures.

### Embodiment 5

The method of any of Embodiments 1 to 4, wherein the set of pictures comprises at least one picture.

### Embodiment 6

The method of any of Embodiments 1 to 5, wherein the recovery point indication is preceded by the set of unavailable reference pictures and is followed by the set of pictures.

### Embodiment 7

The method of any of Embodiments 1 to 6, wherein the set of pictures includes references to the set of unavailable reference pictures.

### Embodiment 8

The method of any of Embodiments 1 to 7, wherein generating the set of unavailable reference pictures from the derived information includes generating the set of unavailable reference pictures before starting the decoding of any picture in the set of pictures.

### Embodiment 9

The method of any of Embodiments 1 to 8, wherein the set of syntax elements comprises a set of recovery point indication syntax elements.

### Embodiment 10

The method of any of Embodiments 1 to 9, wherein the set of syntax elements includes at least one syntax element.

### Embodiment 11

The method of any of Embodiments 1 to 10, wherein the set of pictures includes a recovery point period starting at the first picture and ending at a recovery point picture.

### Embodiment 12

The method of any of Embodiments 1 to 11, wherein decoding the set of pictures after generation of the set of unavailable reference pictures includes a video that is fully refreshed at the recovery point picture if the decoding is started at the first picture and all other pictures in the recovery point period following the first picture and preceding the recovery point picture in the decoding order and including the recovery point picture are decoded.

### Embodiment 13

The method of any of Embodiments 1 to 12, wherein the recovery point indication further includes specifying an end picture of the recovery point period in the bitstream.

### Embodiment 14

The method of any of Embodiments 1 to 13, wherein deriving information for generating the set of unavailable reference pictures from the decoded set of syntax elements includes at least one of:
Deriving at least one parameter set identifier that identifies a parameter set that is active for the first picture in the set of pictures;
Deriving a number of unavailable reference pictures in the set of unavailable reference pictures to generate;
Deriving a picture order count value for each picture in the set of the unavailable reference pictures and assigning a derived picture order count value to each of the associated pictures in the set of unavailable reference pictures;
Deriving a picture order count value for the first picture in the set of pictures, deriving delta values for a delta picture order count for each of the pictures in the set of unavailable reference pictures relative to the picture order count value for the first picture in the set of pictures, and using the derived delta values to calculate a picture order count value for each of the pictures in the set of unavailable reference pictures and assigning the calculated picture order count values to each of the associated unavailable reference pictures;
Deriving a picture marking status for each picture in the set of unavailable reference pictures, wherein the picture marking status is at least one of: a long-term picture, a short-term picture, and a mark each picture in the set of unavailable reference pictures with a derived marking status;
Deriving a luma width value and a luma height value and generating each picture in the set of unavailable reference pictures having the luma width value and the luma height value;
Deriving a luma width value and a luma height value for each picture in the set of unavailable pictures and generating each picture in the set of unavailable reference pictures to have a width and a height of the associated derived luma width and height value;
Deriving a number of components of the unavailable reference pictures comprising a relative dimension value for each of the components and a bit-depth value for each of the components; and generating each picture in the set of unavailable reference pictures having the number of components, the relative dimensions and the bit-depth according to the derived values;
Deriving a picture type value for each picture in the set of unavailable reference pictures and assigning the derived picture type values to each of an associated unavailable reference picture in the set of unavailable reference pictures;
Deriving a temporal identity value for each of the pictures in the set of unavailable reference pictures and assigning the derived temporal identity values to each of an associated unavailable reference picture in the set of unavailable reference pictures;
Deriving a layer identity value for each of the pictures in the set of unavailable reference pictures and assigning a derived layer identity value to each of an associated unavailable reference picture in the set of unavailable reference pictures;
Deriving at least one picture parameter set identifier for each of the pictures in the set of unavailable reference pictures and assigning the derived at least one picture parameter set identifier values to each of an associated unavailable reference picture in the set of unavailable reference pictures; and
Deriving a block size comprising a size of a coding tree unit, generating each picture in the set of unavailable reference pictures to have that block size, and assigning the block size to each of an unavailable reference picture in the set of unavailable reference pictures.

### Embodiment 15

The method of any of Embodiments 1 to 14, wherein the decoded set of syntax elements is decoded from a recovery point indication in a non-video coding layer (non-VCL) network abstraction layer (NAL) having a non-VCL NAL unit type that indicates that the non-VCL NAL unit is a recovery point indication non-VCL NAL unit.

### Embodiment 16

The method of any of Embodiments 1 to 15, wherein generating the set of unavailable reference pictures includes allocating or assigning memory to store values for each of the pictures in the set of unavailable reference pictures, wherein the stored values includes sample values for each component of each picture in the set of unavailable reference pictures.

### Embodiment 17

The method of any of Embodiments 4 to 16, wherein generating each of the pictures in the set of unavailable reference pictures includes at least one of:
Setting a number of components for the picture in the set of unavailable reference pictures;
Setting a width and a height for each component of the picture in the set of unavailable reference pictures;
Setting a sample bit depth for each component of the picture in the set of unavailable reference pictures;
Setting a sample value for each sample in the picture in the set of unavailable reference pictures;
Assigning a PPS identifier to the picture in the set of unavailable reference pictures;
Assigning a SPS identifier to the picture in the set of unavailable reference pictures;
Assigning an identifier to the picture in the set of unavailable reference pictures, wherein the identifier comprises a picture order count value;
Marking the picture in the set of unavailable reference pictures as at least one of: a short-term picture, a long-term picture, and an unused for prediction;
Assigning a picture type to the picture in the set of unavailable reference pictures;
Assigning a temporal ID to the picture in the set of unavailable reference pictures;
Assigning a layer ID to the picture in the set of unavailable reference pictures;
Assigning a block size for each component of the picture in the set of unavailable reference pictures; and
Marking the picture in the set of unavailable reference pictures as initialized.

### Embodiment 18

The method of any of Embodiments 1 to 17, wherein the set of syntax elements is decoded from a picture header.

### Embodiment 19

The method of any of Embodiments 1 to 18, wherein the recovery point indication is decoded from a video coding layer (VCL) network abstraction level (NAL) unit including a NAL unit type syntax element, and wherein the decoded syntax element includes at least one of: a start position of a recovery point and an end position of the recovery point period.

### Embodiment 20

The method of any of Embodiments 1 to 19, wherein the decoded set of syntax elements is decoded from a supplemental enhancement information (SEI) message.

### Embodiment 21

The method of any of Embodiments 1 to 20, wherein the decoded set of syntax elements is decoded from a picture parameter set including at least one of: a picture parameter set (PPS) and sequence parameter set (SPS).

### Embodiment 22

The method of any of Embodiments 1 to 21, wherein the bitstream starts with the starting position in the bitstream specified by the recovery point.

### Embodiment 23

The method of Embodiment 22, wherein the bitstream includes a conforming part of the bitstream that conforms to a standard specification and wherein the decoding decodes the conforming part of the bitstream.

### Embodiment 24

The method of Embodiment 23, wherein the conforming part of the bitstream is a CVS.

### Embodiment 25

The method of any of Embodiments 1 to 24, wherein the recovery point indication is valid for a spatial subset of each picture in the set of pictures.

### Embodiment 26

The method of any of Embodiments 1 to 25, wherein the first picture in the set of pictures is followed by a second picture in the set of pictures, wherein the first and second pictures are different pictures, and wherein the second picture follows the first picture in decoding order.

### Embodiment 27

The method of any of Embodiments 1 to 26, wherein the recovery point indication includes a normative indication of the recovery point and wherein the normative indication of the recovery point includes a temporal position of at least of a first and a second picture in the set of pictures.

### Embodiment 28

The method of any of Embodiments 1 to 27, wherein the decoding the set of pictures is initialized at the recovery point. The method further includes determining (1700) a position of a first picture in the set of pictures. The method further includes determining (1702) a position of a second picture in the set of pictures. The method further includes decoding (1704) the first picture and all other pictures in the set of pictures in the recovery period before the second picture in the decoding order without outputting the decoded pictures. The method further includes decoding and outputting (1706) the second picture.

### Embodiment 29

The method of any of Embodiments 1 to 28, further including performing (1800) a random access operation at the recovery point.

### Embodiment 30

The method of any of Embodiments 1 to 29, wherein the recovery point indication and a first picture in the set of pictures belong to the same access unit.

### Embodiment 31

The method of any of Embodiments 1 to 30, wherein a normative indication of the recovery point is ignored if at least one of: the recovery point does not start the bitstream and a random access operation is not performed at the recovery point.

### Embodiment 32

The method of any of Embodiments 1 to 31, wherein the normative recovery point indication is not contained in a supplemental enhancement information (SEI) message decoded from the set of syntax elements.

### Embodiment 33

The method of any of Embodiments 1 to 32, wherein the set of unavailable reference pictures includes all unavailable reference pictures in the bitstream before the first picture in the set of pictures in the decoding order and wherein the decoding the set of pictures uses the set of unavailable reference pictures for decoding all pictures in the set of pictures in decoding order starting from the first picture in the bitstream in the set of pictures and ending with the second picture in the bitstream in the set of pictures.

### Embodiment 34

The method of any of Embodiments 1 to 33 further including: rendering (1900) each picture in the set of pictures for display on a screen based on decoding the pictures from the bitstream after generation of the set of unavailable reference pictures.

### Embodiment 35

The method of any of Embodiments 1 to 34 further including: receiving (2000) the bitstream over a radio and/or network interface from a remote device.

### Embodiment 36

A decoder (2100) configured to operate to decode a set of pictures from a bitstream, including a processor (2104); and memory (2106) coupled with the processor (2104). The memory (2106) includes instructions that when executed by the processor (2104) causes the decoder (2100) to perform operations according to any of Embodiments 1 to 35.

### Embodiment 37

A computer program including program code (2108) to be executed by a processor (2104) of a decoder (2100) configured to operate to decode a set of pictures from a bitstream, whereby execution of the program code (2108) causes the decoder (2100) to perform operations according to any of Embodiments 1 to 35.

### Embodiment 38

A method of encoding a recovery point indication with information of how to generate unavailable reference pictures in a bitstream. The method includes encoding (2300) a first set of pictures to the bitstream. The method further includes determining (2302) a set of reference pictures that would be unavailable to a decoder if decoding started in the bitstream after the first set of pictures. The method further includes encoding (2304) a recovery point indication to the bitstream. The recovery point indication includes a set of syntax elements for the set of reference pictures. The method further includes encoding (2306) a second set of pictures to the bitstream. The at least one picture in the second set of pictures references a picture from the first set of pictures.

### Embodiment 39

The method of Embodiment 38, wherein the first set of pictures includes at least one picture.

### Embodiment 40

The method of any of Embodiments 38 to 39, wherein the set of reference pictures includes at least one reference picture.

### Embodiment 41

The method of any of Embodiments 38 to 40, wherein the set of syntax elements includes at least one syntax element for at least one picture in the set of reference pictures.

### Embodiment 42

An encoder (2200) configured to operate to encode a recovery point indication with information of how to generate unavailable reference pictures in a bitstream, including: a processor (2204); and memory (2206) coupled with the processor (2204). The memory (2206) includes instructions that when executed by the processor (2204) causes the encoder (2200) to perform operations according to any of Embodiments 38 to 41.

### Embodiment 43

A computer program including program code (2208) to be executed by a processor (2204) of an encoder (2200) configured to operate to encode a recovery point indication with information of how to generate unavailable reference pictures in a bitstream, whereby execution of the program code (2208) causes the encoder (2200) to perform operations according to any of Embodiments 38 to 41.

### Further Definitions and Embodiments are Discussed Below

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of decoding a set of pictures from a video bitstream, the method comprising:
identifying a recovery point in the video bitstream from a recovery point indication, wherein the recovery point specifies a starting position in the video bitstream for decoding the set of pictures, wherein the set of pictures includes a first picture that is the first picture that follows the recovery point indication in a decoding order in the set of pictures and wherein the set of pictures include coded picture data;
decoding the recovery point indication to obtain a decoded set of syntax elements, wherein the recovery point indication comprises the set of syntax elements;
deriving information for generating a set of unavailable reference pictures from the decoded set of syntax elements before any of the coded picture data included in the set of pictures is parsed;
generating the set of unavailable reference pictures based on the derived information; and
decoding the set of pictures after generating the set of unavailable reference pictures.

2. The method of claim 1, wherein the set of syntax elements is decoded from a picture header.

3. The method of claim 1, wherein the coded picture data includes all VCL NAL units included in the set of pictures in the video bitstream.

4. The method of claim 1, wherein the generating is done before any of the coded picture data included in the set of pictures is parsed.

5. The method of claim 1, wherein the first picture includes a block that is not an intra coded block.

6-8. (canceled)

9. The method of claim 1, wherein the set of pictures includes references to the set of unavailable reference pictures.

10-12. (canceled)

13. The method of claim 1, wherein the set of pictures comprises a recovery point period starting at the first picture and ending at a recovery point picture.

14. The method of claim 13, further comprising, after generating the set of unavailable reference pictures, decoding the first picture in the set of pictures and all other pictures in the recovery point period following the first picture, up to and including the recovery point picture, thereby to refresh fully a video carried in the video bitstream.

15. (canceled)

16. The method of claim 1, wherein deriving information for generating the set of unavailable reference pictures from the decoded set of syntax elements comprises at least one of:
deriving at least one parameter set identifier that identifies a parameter set that is active for the first picture in the set of pictures;
deriving a number of unavailable reference pictures in the set of unavailable reference pictures to generate;
deriving a picture order count value for each picture in the set of the unavailable reference pictures and assigning a derived picture order count value to each of the associated pictures in the set of unavailable reference pictures;
deriving a picture order count value for the first picture in the set of pictures, deriving delta values for a delta picture order count for each of the pictures in the set of unavailable reference pictures relative to the picture order count value for the first picture in the set of pictures, and using the derived delta values to calculate a picture order count value for each of the pictures in the set of unavailable reference pictures and assigning the calculated picture order count values to each of the associated unavailable reference pictures;
deriving a picture marking status for each picture in the set of unavailable reference pictures, wherein the picture marking status is at least one of: a long-term picture, a short-term picture, and a mark each picture in the set of unavailable reference pictures with a derived marking status;
deriving a luma width value and a luma height value and generating each picture in the set of unavailable reference pictures having the luma width value and the luma height value;
deriving a luma width value and a luma height value for each picture in the set of unavailable pictures and generating each picture in the set of unavailable reference pictures to have a width and a height of the associated derived luma width and height value;
deriving a number of components of the unavailable reference pictures comprising a relative dimension value for each of the components and a bit-depth value for each of the components; and generating each picture in the set of unavailable reference pictures having the number of components, the relative dimensions and the bit-depth according to the derived values;
deriving a picture type value for each picture in the set of unavailable reference pictures and assigning the derived picture type values to each of an associated unavailable reference picture in the set of unavailable reference pictures;
deriving a temporal identity value for each of the pictures in the set of unavailable reference pictures and assigning the derived temporal identity values to each of an associated unavailable reference picture in the set of unavailable reference pictures;
deriving a layer identity value for each of the pictures in the set of unavailable reference pictures and assigning a derived layer identity value to each of an associated unavailable reference picture in the set of unavailable reference pictures;
deriving at least one picture parameter set identifier for each of the pictures in the set of unavailable reference pictures and assigning the derived at least one picture parameter set identifier values to each of an associated unavailable reference picture in the set of unavailable reference pictures; and
deriving a block size comprising a size of a coding tree unit, generating each picture in the set of unavailable reference pictures to have that block size, and assigning the block size to each of an unavailable reference picture in the set of unavailable reference pictures.

17. The method of claim 1, wherein the decoded set of syntax elements is decoded from a recovery point indication in a non-video coding layer (non-VCL) network abstraction layer (NAL).

18. The method of claim 1, wherein generating the set of unavailable reference pictures comprises allocating or assigning memory to store values for each of the pictures in the set of unavailable reference pictures, wherein the stored values includes sample values for each component of each picture in the set of unavailable reference pictures.

19. The method of claim 1, wherein the set of unavailable reference pictures comprises at least one unavailable reference picture and wherein generating a set of unavailable reference pictures comprises generating each of the pictures in the set of unavailable reference pictures, and wherein generating each of the pictures in the set of unavailable reference pictures comprises at least one of:
setting a number of components for the picture in the set of unavailable reference pictures;
setting a width and a height for each component of the picture in the set of unavailable reference pictures;
setting a sample bit depth for each component of the picture in the set of unavailable reference pictures;
setting a sample value for each sample in the picture in the set of unavailable reference pictures;
assigning Assigning a PPS identifier to the picture in the set of unavailable reference pictures;
assigning Assigning a SPS identifier to the picture in the set of unavailable reference pictures;
assigning Assigning an identifier to the picture in the set of unavailable reference pictures, wherein the identifier comprises a picture order count value;
marking the picture in the set of unavailable reference pictures as at least one of: a short-term picture, a long-term picture, and an unused for prediction;
assigning Assigning a picture type to the picture in the set of unavailable reference pictures;
assigning Assigning a temporal ID to the picture in the set of unavailable reference pictures;
assigning Assigning a layer ID to the picture in the set of unavailable reference pictures;
assigning Assigning a block size for each component of the picture in the set of unavailable reference pictures; and
marking the picture in the set of unavailable reference pictures as initialized.

20. The method of claim 1, wherein the recovery point indication is decoded from a video coding layer (VCL) network abstraction level (NAL) unit including a NAL unit type syntax element, and wherein the decoded syntax element comprises at least one of: a start position of a recovery point and an end position of the recovery point period.

21-29. (canceled)

30. The method of claim 1, further comprising performing a random access operation at the recovery point.

31. The method of claim 1, wherein the recovery point indication and a first picture in the set of pictures belong to the same access unit.

32-36. (canceled)

37. A decoder configured to operate to decode a set of pictures from a video bitstream, comprising:
a processor; and
memory coupled with the processor, wherein the memory includes instructions that when executed by the processor causes the decoder to perform operations according to claim 1.

38. A computer program comprising program code to be executed by a processor of a decoder configured to operate to decode a set of pictures from a video bitstream, whereby execution of the program code causes the decoder to perform operations according to claim 1.

39. A method of encoding a recovery point indication into a video bitstream, the method comprising:
encoding a first set of pictures to the video bitstream;
determining a set of reference pictures that would be unavailable to a decoder if decoding started in the video bitstream after the first set of pictures;
encoding a recovery point indication into the video bitstream, wherein the recovery point indication includes a set of syntax elements for the set of reference pictures that would be unavailable, thereby providing information to enable a decoder to generate a picture in the set of unavailable reference pictures before parsing a second set of pictures in the video bitstream, the second set of pictures including at least one picture that references a picture in the first set of pictures; and
encoding the second set of pictures into the video bitstream.

40-42. (canceled)

43. An encoder configured to operate to encode into a video bitstream a recovery point indication including information to enable a decoder to generate a picture in a set of unavailable reference pictures, comprising:
a processor; and
memory coupled with the processor, wherein the memory includes instructions that when executed by the processor causes the encoder to perform operations according to claim 39.

44. A computer program comprising program code to be executed by a processor of an encoder configured to operate to encode into a video bitstream a recovery point indication including information to enable a decoder to generate a picture in a set of unavailable reference pictures, whereby execution of the program code causes the encoder to perform operations according to claim 39.

45. The method of claim 39, wherein encoding a recovery point indication into the video bitstream comprises encoding the set of syntax elements into a picture header.
